(19) United States
(12) Patent Application Publication
(10) Pub. No.: US 2026/0210111 A1
(43) Pub. Date: Jul. 23, 2026

(54) HEAT AND MOISTURE RESISTANT VERTICAL SHAFT LINERS MADE USING LIGHTWEIGHT COMPOSITE PANELS

(71) Applicant: HYDROBLOK, INC., Park City, UT (US)

(72) Inventors: Brian DUNN, Draper, UT (US); Alex GILLESPIE, Draper, UT (US)

(21) Appl. No.: 19/454,347

(22) Filed: Jan. 20, 2026

Related U.S. Application Data
(60) Provisional application No. 63/747,543, filed on Jan. 21, 2025.

(51) Int. Cl. E04B 1/94; B66B 11/00; B66B 19/00

(52) U.S. Cl. CPC E04B 1/94; B66B 11/0005; B66B 19/007

(57) ABSTRACT

Heat and moisture resistant shaft liners include: a shaft liner frame formed around at least a portion of a perimeter of the vertical shaft, main lightweight composite panels positioned within the shaft liner frame and forming main vertical shaft walls, vertical studs positioned in the shaft liner frame and interconnecting adjacent vertical shaft wall columns lying in the same plane, and auxiliary vertical shaft walls comprising additional lightweight composite panels and/or gypsum boards fastened to the shaft liner frame. Lightweight composite panels include a foam core and fiber mesh reinforced cementitious or other protective layers formed on the foam core surfaces. The vertical shaft can be an elevator shaft, stairwell shaft, mechanical chase, or an air shaft. The shaft liner frame can include metal (e.g., steel) J-tracks forming a perimeter around the vertical shaft walls. The vertical studs can be C-T studs, C-H studs, or I-studs.

### CROSS-REFERENCE TO RELATED APPLICATION

This application claims the benefit of U.S. Provisional Application No. 63/747,543, filed Jan. 21, 2025, which is incorporated by reference in its entirety.

### BACKGROUND

### Technical Field

This disclosure relates to methods and systems for making vertical shaft liners, such as for elevator shafts, stairwell shafts, mechanical chases, and air shafts using lightweight composite panels.

### Related Technology

Vertical shafts, such as elevator shafts, stairwell shafts, mechanical chases, and air shafts, are critical components in building construction. Vertical shaft liners are designed to provide enclosures that protect people, equipment, and air flows from outside risks, including protecting against fire and smoke during emergencies, ensuring occupant safety, and limiting property damage. Building codes require vertical shaft enclosures to meet strict fire resistance standards and often require materials that can withstand intense heat and flame for extended periods (e.g., ASTM E119 fire test).

Traditional shaft liner systems are typically made using gypsum-based panels and face several limitations with respect to fire resistance, vulnerability to moisture, poor insulation, and high weight, resulting in labor-intensive installation. While gypsum-based shaft liners can achieve fire resistance, multiple layers or thick assemblies are often required, increasing weight, material use, cost, and labor. Gypsum-based panels are highly susceptible to water damage, mold growth, and structural degradation in high-humidity environments and areas prone to water leaks. Gypsum-based shaft liners offer limited thermal resistance, reducing energy efficiency in shafts exposed to external temperature differentials. Finally, traditional gypsum-based panels used as shaft liner materials can be more than four times heavier than traditional gypsum boards used as ordinary wallboard, increasing labor costs, building envelope weight, and the risk of injury to workers.

Accordingly, there is a need for improved shaft liners and methods and systems for constructing shaft liners, including shaft liner panels that can reduce time, weight, and labor costs, and improve overall performance compared to traditional shaft liner panels.

### SUMMARY

Disclosed are methods and systems for constructing shaft liners for vertical shafts, such as elevator shafts, stairwell shafts, mechanical chases, and air shafts, that address and overcome problems associated with traditional shaft liners. In one aspect of the invention, lightweight composite panels of various thicknesses can be used in making shaft liners together with existing tracks, runners, studs, or other structural elements, which are typically made of metal (e.g., steel) for strength and fire resistance. The methods and systems for making improved shaft liners significantly reduce time, weight, and labor costs compared to traditional shaft liners.

In some embodiments, a method of constructing a shaft liner comprises: (1) forming or providing a three-dimensional shaft liner frame around at least a portion of a vertical shaft, the shaft liner frame comprising upper tracks or runners with down-facing flanges and channels and lower tracks or runners with up-facing flanges and channels; (2) positioning main lightweight composite panels within the shaft liner frame to form main vertical shaft walls extending between the upper and lower tracks or runners, each main vertical shaft wall comprising adjacent vertical shaft wall columns, and each main vertical shaft wall being angled relative to adjacent main vertical shaft walls so that the main vertical shaft walls at least partially enclose the vertical shaft; (3) positioning vertical studs having side-facing flanges and channels in the shaft liner frame to interconnect adjacent vertical shaft wall columns that lie in the same plane, each vertical stud being positioned next to an installed vertical shaft wall column prior to installing another vertical shaft wall column adjacent to the installed vertical shaft wall column in the same plane; and (4) fastening a plurality of auxiliary panels to the shaft liner frame to form one or more auxiliary vertical walls, the auxiliary panels comprising additional lightweight composite panels and/or gypsum boards, each auxiliary vertical wall being angled relative to one or more adjacent auxiliary vertical walls to at least partially enclose or hide the shaft liner frame, (5) the lightweight composite panels each comprising: (a) polymer and/or inorganic foam core having a first surface and a second surface; (b) a first protective layer selected from a first fiber reinforced cementitious layer, thermoset polymer layer, or magnesium oxide layer formed over and covering at least a portion of the first surface of the foam core; and (c) a second protective layer selected from a second fiber reinforced cementitious layer, thermoset polymer layer, or magnesium oxide layer formed over and covering at least a portion of the second surface of the foam core.

In some embodiments, a shaft liner comprises: (1) a three-dimensional shaft liner frame formed around at least a portion of a vertical shaft, the shaft liner frame comprising upper tracks or runners with down-facing flanges and channels and corresponding lower tracks or runners with up-facing flanges and channels; (2) main lightweight composite panels positioned within the shaft liner frame and forming main vertical shaft walls extending between the upper and lower tracks or runners, each main vertical shaft wall comprising adjacent vertical shaft wall columns, and each main vertical shaft wall being angled relative to adjacent main vertical shaft walls so that the main vertical shaft walls at least partially enclose the vertical shaft; (3) vertical studs having side-facing flanges and channels positioned in the shaft liner frame and interconnecting adjacent vertical shaft wall columns in the same plane; and (4) a plurality of auxiliary panels fastened to the shaft liner frame and forming one or more auxiliary vertical walls, the auxiliary panels comprising additional lightweight composite panels and/or gypsum boards, each auxiliary vertical wall being angled relative to one or more adjacent auxiliary vertical walls to at least partially enclose or hide the shaft liner frame, (5) the lightweight composite panels each comprising: (a) polymer and/or inorganic foam core having a first surface and a second surface; (b) a first protective layer selected from a first fiber reinforced cementitious layer, thermoset polymer layer, or magnesium oxide layer formed over and covering at least a portion of the first surface of the foam core; and (c) a second protective layer selected from a second fiber reinforced cementitious layer, thermoset polymer layer, or magnesium oxide layer formed over and covering at least a portion of the second surface of the foam core.

The three-dimensional shaft liner frame further comprises first and second vertical tracks or runners with side-facing flanges and channels positioned adjacent to and partially enclosing first and second vertical side ends, respectively, of each main vertical shaft wall. In a typical installation method, a first vertical track or runner is secured to the upper and lower tracks or runners, a first vertical shaft column is then installed adjacent to the first vertical track or runner forming the first vertical side end of the main vertical shaft wall, followed by installing alternating vertical studs and additional vertical shaft columns to form the main vertical shaft wall. Then a second vertical track or runner is secured to the upper and lower tracks or runners to partially enclose the second side end of the main vertical shaft wall. In this way, the shaft liner frame can enclose and support each main vertical shaft wall on all four sides. Because vertical shafts typically extend through multiple stories of a building, the shaft liner can comprise multiple vertically stacked three-dimensional shaft liner frames and multiple vertically stacked main vertical shaft walls positioned so as to at least partially enclose the vertical shaft along its entire height.

In some embodiments, the shaft liner encloses an elevator shaft. In such cases, it may be desirable for the shaft liner to further comprise one or more auxiliary vertical walls fastened to the side shaft liner frame facing away from the elevator shaft. In some embodiments, a first auxiliary vertical wall can be fastened to the shaft liner frame to provide additional heat and fire resistance to the shaft liner, and a second auxiliary vertical wall can be fastened to the shaft liner frame over the first auxiliary vertical wall to function as a show wall that is visible outside the elevator shaft. The show wall(s) can cover and hide the first auxiliary vertical wall(s) and may also provide additional heat and fire resistance to the shaft liner.

In other embodiments, the shaft liner encloses a stairwell shaft. In such cases, it may be desirable for the shaft liner to further comprise one or more auxiliary vertical walls fastened to the shaft liner frame to provide additional heat and fire resistance. In some embodiments, first auxiliary vertical walls are fastened to a side of the shaft liner frame facing into the stairwell shaft and can function as show walls that are visible inside the stairwell shaft, and second auxiliary vertical walls are fastened to a side of the shaft liner frame facing away from the stairwell shaft and may or may not function as show walls.

In some embodiments, the tracks or runners used to make the shaft liner frame may comprise metal (e.g., steel) J-tracks or J-runners having a center wall and two spaced apart sidewalls extending laterally from the center wall, wherein a first sidewall is longer than a second sidewall. The longer sidewalls of the J-tracks or J-runners are typically on the vertical shaft side of the shaft liner frame and, together with flanges within the channels of the J-tracks or J-runners, retain main the lightweight composite panels within the shaft liner frame in a desired position (e.g., in a friction fit configuration). The shorter sidewalls of the J-tracks or J-runners are typically on the side of the shaft liner frame opposite the vertical shaft side, which aids in installing the main lightweight composite panels in the shaft liner frame. One or both of the longer and shorter sidewalls can function as flanges to which auxiliary panels can be fastened. In the case of an elevator shaft, the auxiliary panels can both be fastened to the shorter sidewalls. In the case of a stairwell shaft, first auxiliary panels can both be fastened to the longer sidewalls and second auxiliary panels can be fastened to the shorter sidewalls.

In some embodiments, the vertical studs are metal (e.g., steel) and are selected from C-T studs, C-H studs, or I-studs. Such studs can have a T- or H-shaped region with flanges on one side that make abutment with the J-tracks or J-runners and receive and interconnect lightweight composite panels used to make adjacent vertical shaft wall columns. In this way, the C-T studs, C-H studs, or I-studs cooperate with the J-tracks or J-runners to retain the lightweight composite panels within the shaft liner frame in a desired position (e.g., in a friction fit configuration, typically without the need for screws or other fasteners). Such studs can also have a region opposite the T- or H-shaped region, which can be C-shaped, in order to provide space between the vertical shaft walls and the exterior vertical show walls and also a flange to which the lightweight composite panels used to make the exterior vertical show walls can be fastened. The flanges of the C-T studs, C-H studs, or I-studs cooperate with the shorter sidewalls or flanges of the J-tracks or J-runners to provide strong fixation of the exterior vertical show walls.

In some embodiments, the vertical shaft liners are constructed to provide a 2-hour fire rating. In order for the vertical shaft walls to provide a desired level of fire and heat resistance, and also increased sound resistance, the main lightweight composite panels used to make the main vertical shaft walls can have a cross-sectional thickness in a range of about ¾ inch to about 1½ inch, or about ⅞ inch to about 1¼ inch, or about 1 inch. Similarly, to provide additional fire and heat resistance, but while reducing overall thickness of the shaft liner, the lightweight composite panels and/or gypsum boards used to make the auxiliary vertical walls can have a cross-sectional thickness in a range of about ⅜ inch to about ⅝ inch, or about 7/16 inch to about 9/16 inch, or about ½ inch.

In some embodiments, lightweight composite panels used to make show walls (i.e., interior and/or exterior show walls of the vertical shaft liner) can have a polymer finish, plaster finish, or paper layer applied over the surface of the fiber mesh reinforced cementitious or other protective layer that faces away from the shaft liner frame. The polymer finish, plaster finish, or paper layer can provide a surface to which a desired finish can be applied, such as paint or wallpaper. Alternatively, where the show wall is covered with tile, stone, or other surface finishes that are adhered to the lightweight composite panels, it may be desirable to omit the plaster or paper layer in order to provide a rougher bonding surface.

The lightweight composite panels can be fastened to the shaft liner frame using mechanical fasteners and adhesives known in the art, such as sheet metal screws, rivets, and construction adhesive. Strips of tape can be used as a template to ensure proper placement of screws or other mechanical fasteners when fastening lightweight composite panels to studs or other structural elements of the shaft liner frame. To prevent screws from tearing through the exterior fiber mesh reinforced cementitious layer, screws can be used with enlarged washers having high surface area to distribute the pressure or load over a high surface area of the lightweight composite panels. Specialized washers with penetrating prongs can be used to limit rotation and penetration, preventing damage to the lightweight composite panels. Rectangular washers with multiple prongs on either side of the screw can be used to tie adjacent lightweight composite panels together.

In shaft wall and shaft liner assemblies, the main vertical shaft wall is formed using lightweight composite panels of relatively high thickness (e.g., about 1 inch), which remains present as the core liner component of the heat and fire rated assembly. As stated above, additional lightweight composite panels can be installed to form auxiliary vertical walls and/or vertical show walls. It is also within the scope of the present disclosure to utilize conventional gypsum boards in combination with the main lightweight composite shaft wall panel, including as a substitute for lightweight composite panels to construct vertical show walls and/or auxiliary vertical walls of shaft liners, such as for one or more show-side or occupied-space-facing walls, such as stairwell or corridor sides of shaft and stairwell enclosures. In such configurations, the lightweight composite panels forming the main vertical shaft wall continue to provide the primary shaft liner function, while the gypsum boards can provide a finished-facing surface and/or auxiliary vertical wall for increased fire and heat protection. Although gypsum boards are generally heavier than the lightweight composite panels disclosed herein, they are typically thinner, lighter, and more manageable than the typical thick gypsum boards used to make the main vertical shaft wall om conventional shaft liners.

Additional features and advantages will be set forth in part in the description that follows, and in part will be obvious from the description, or may be learned by practice of the embodiments disclosed herein. It is to be understood that both the foregoing brief summary and the following detailed description are exemplary and not restrictive of the embodiments disclosed herein or as claimed

### BRIEF DESCRIPTION OF THE DRAWINGS

Various objects, features, characteristics, and advantages of the invention will become apparent and more readily appreciated from the following description of the embodiments, taken in conjunction with the accompanying drawings and the appended claims, all of which form a part of this specification. In the Drawings, like reference numerals may be utilized to designate corresponding or similar parts in the various Figures, and the various elements depicted are not necessarily drawn to scale, wherein:

FIG. 1 illustrates a main vertical shaft wall of a vertical shaft liner, which includes a shaft liner frame and a plurality of vertical shaft wall columns formed using lightweight composite panels separated and interconnected by vertical studs;

FIG. 2A illustrates an example J-track or J-runner for use in making a shaft liner frame to which main lightweight composite panels are inserted or attached to make a main vertical shaft wall;

FIG. 2B illustrates an example C-T stud for use in interconnecting vertical shaft wall columns made using lightweight composite panels to make the main vertical shaft walls;

FIG. 2C illustrates an example C-H stud for use in interconnecting vertical shaft wall columns made using lightweight composite panels to make the main vertical shaft walls;

FIG. 2D illustrates an example I-stud for use in interconnecting vertical shaft wall columns made using lightweight composite panels to make the main vertical shaft walls;

FIG. 3A illustrates a partially constructed shaft liner frame made using J-tracks or J-runners and that includes an upper track or runner, a lower track or runner, and a first vertical track or runner forming a first side of the shaft liner frame;

FIG. 3B illustrates the partially constructed shaft liner frame of FIG. 3A with a first vertical shaft wall column made from one or more main lightweight composite panels positioned between the side track or runner and a first vertical stud to make a partially constructed main vertical shaft wall;

FIG. 3C illustrates the partially constructed main vertical shaft wall of FIG. 3B with a second vertical shaft wall column made from one or more main lightweight composite panels being inserted into an upper channel of the upper track or runner;

FIG. 3D illustrates the partially constructed main vertical shaft wall of FIGS. 3B and 3C with the second vertical shaft wall column having been inserted into a lower channel of the lower track or runner prior to moving the second vertical shaft wall column toward the first vertical stud;

FIG. 3E illustrates the partially constructed main vertical shaft wall of FIGS. 3B-3D with three vertical shaft wall columns having been inserted into the shaft liner frame and interconnected by vertical studs positioned between adjacent vertical shaft wall columns;

FIG. 3F illustrates a main vertical shaft wall comprising a shaft liner frame with a second vertical track or runner forming a second side of the shaft liner frame to as to form a complete shaft liner frame that forms a perimeter around all four sides of the main vertical shaft wall, including three vertical shaft wall columns and two vertical studs;

FIG. 4A illustrates an elevator shaft liner with a plurality of main vertical shaft walls formed using a three-dimensional shaft liner frame, a plurality of vertical shaft wall columns in the shaft liner frame interconnected by vertical studs, and an elevator door opening with a door frame made using tracks or runners;

FIG. 4B illustrates the elevator shaft liner of FIG. 4A with an auxiliary vertical wall made using a plurality of lightweight composite panels and/or gypsum boards fastened to an exterior side of the shaft liner frame and door frame;

FIG. 4C illustrates the elevator shaft liner of FIGS. 4A and 4B with a show wall made using a plurality of lightweight composite panels and/or gypsum boards placed over the auxiliary vertical wall and fastened to the exterior side of the shaft liner frame and door frame and an elevator door having been installed within the door frame;

FIG. 5 is a perspective side view that illustrates an example configuration of a vertical shaft liner for an elevator shaft, including a C-T stud, a main vertical shaft wall formed by a pair of vertical shaft wall columns made using main lightweight composite panels interconnected by the C-T stud, a first auxiliary vertical wall fastened to a side of the C-T stud opposite the vertical shaft wall, and a second auxiliary vertical wall (e.g., exterior show wall) fastened to the C-T stud adjacent to the first auxiliary vertical wall;

FIG. 6 is a perspective side view that illustrates an example configuration of a vertical shaft liner for a stairwell shaft, including a C-T stud, a vertical shaft wall formed by a pair of vertical shaft wall columns made using main lightweight composite panels interconnected by the C-T stud, a first auxiliary vertical wall (e.g., interior show wall) fastened to the C-T stud adjacent to the main vertical shaft wall, and a second auxiliary vertical wall (e.g., exterior show wall) fastened to a side of the C-T stud opposite the main vertical shaft wall;

FIG. 7A is a side perspective view that illustrates examples of differently-sized lightweight composite panels that can be used to make shaft liners of the disclosure, including main vertical shaft liners and auxiliary vertical walls;

FIG. 7B is a top perspective view that illustrates the differently-sized lightweight composite panels of FIG. 7A;

FIG. 8A is a perspective view that illustrates an example composite wall panel, with the different layers being visible, including a textured finish layer;

FIGS. 8B-8D illustrate an example composite wall panel, with the different layers being visible, including a smooth finish layer;

FIG. 9 is a perspective view that schematically illustrates an embodiment of a composite wall panel with bevels extending to each of the four edges;

FIG. 10A is a cross-sectional view that schematically illustrates the layered structure of an embodiment of a composite wall panel with beveled edges;

FIG. 10B is an exploded diagram that schematically illustrates the layered structure of the composite wall panel of FIG. 10A;

FIG. 11A is a cross-sectional view that schematically illustrates the layered structure of another embodiment of a composite wall panel with beveled edges;

FIG. 11B is an exploded diagram that schematically illustrates the layered structure of the composite wall panel of FIG. 11A;

FIG. 12A illustrates a pair of composite wall panels abutting each other, with beveled edges forming a channel or depression that can be filled with tape and drywall patch during installation;

FIG. 12B illustrates a pair of composite wall panels abutting each other, with the beveled edges covered by drywall patch or plaster;

FIG. 13A is a cross-sectional view that schematically illustrates the layered structure of an embodiment of a laminated composite wall panel with beveled edges;

FIG. 13B is an exploded diagram that schematically illustrates the layered structure of the laminated composite wall panel of FIG. 13A;

FIG. 13C illustrates an embodiment of a laminated composite wall panel with beveled edges;

FIG. 14 illustrates another embodiment of a laminated composite wall panel with a planar surface;

FIG. 15 illustrates a composite wall panel with holes caused by screws with heads that penetrated through the finish layer and underlying fiber mesh reinforced cementitious layer and a screw with a washer that did not penetrate through the cementitious layer; and

FIGS. 16A-16D illustrate embodiments of specialized washers with multiple prongs designed to penetrate at least partially through and become embedded within lightweight composite panels used to make vertical shaft liners of the disclosure.

### DETAILED DESCRIPTION

### I. Introduction

Disclosed are methods and systems for constructing vertical shaft liners that include a three-dimensional shaft liner frame, main vertical shaft walls made from main lightweight composite panels positioned within the shaft liner frame and that at least partially enclose a vertical shaft, vertical studs positioned within the shaft liner frame that interconnect adjacent shaft wall columns that lie in the same plane. Auxiliary vertical walls, including hidden interior vertical walls and/or show walls can be made from lightweight composition panels and/or gypsum boards. The vertical shaft liners can at least partially enclose a variety of vertical shafts, such as elevator shafts, stairwell shafts, mechanical chases, and air shafts.

The three-dimensional shaft liner frame and vertical studs are advantageously made of metal so as to be fire and water resistant. The lightweight composite panels do not combust and are waterproof so that the vertical shaft liners of the disclosure are fire resistant, heat resistant, and water resistant. In other words, while excessive heat or fire may be capable of damaging the vertical shaft walls disclosed herein, the vertical shaft walls will not burn and will not propagate fire, which helps prevent the building from burning down. In some embodiments, the vertical shaft liners are constructed to provide a 2-hour fire rating. The main vertical shaft wall made from lightweight composite panels advantageously has a thickness (e.g., 1 inch) sufficient to provide a high level of fire and heat resistance to the vertical shaft liner. The auxiliary vertical walls, including hidden and/or show walls, can have a thickness (e.g., ½ inch) to provide an additional level of fire, heat, and water resistance to the vertical shaft liner. The vertical shaft liner can also provide a level of sound resistance so as to function as a sound barrier.

Additional information relating to lightweight composite panels generally, modifications thereof, and various uses in making interior walls and exterior walls is disclosed in U.S. application Ser. No. 19/306,608, filed Aug. 21, 2025. Additional information relating to lightweight composite panels that include a plaster show layer (e.g., for interior walls) is disclosed in U.S. application Ser. No. 19/306,817, filed Aug. 21, 2025. Additional information relating to lightweight composite panels that include a paper facer (e.g., for interior walls) is disclosed in U.S. application Ser. No. 19/343,312, filed Sep. 29, 2025. Additional information relating to lightweight composite panels that include a cured polymer show layer (e.g., for interior walls) is disclosed in U.S. application Ser. No. 19/343,601, filed Sep. 29, 2025. Additional information relating to lightweight composite panels and their use as substrates in making exterior walls with various applied finishes is disclosed in U.S. application Ser. No. 19/307,007, filed Aug. 21, 2025. Additional information relating to lightweight composite panels and their use as structural sheathing (e.g., for exterior walls and roofing decks) is disclosed in U.S. application Ser. No. 19/306,800, filed Aug. 21, 2025. Additional information relating to lightweight composite panels with a pre-applied drainage layer and their use in making exterior walls is disclosed in U.S. application Ser. No. 19/306,608, filed Aug. 21, 2025. Additional information relating to lightweight composite panels and their use in making subfloors and ceiling systems is disclosed in U.S. application Ser. No. 19/307,024, filed Aug. 21, 2025. Additional information relating to lightweight composite panels and their use in making wall structures is disclosed in U.S. application Ser. No. 19/388,771, filed Nov. 13, 2025. The foregoing applications are incorporated by reference in their entirety

In general, lightweight composite panels, whether used to make main vertical shaft walls, show walls, or hidden auxiliary vertical walls, are fire resistant, heat resistant, and water resistant, can be made airtight so that little or no air flows through the walls, and can provide a surface to which a variety of different finishes can be directly applied. For example, in the case of show walls of a vertical shaft liner, paint, wallpaper, and/or molding (e.g., wainscot, wood paneling, or crown molding) can be applied or adhered directly to the exposed surfaces of lightweight composite panels (e.g., that include an outer plaster, paper, or polymer layer for smoothness). In the case of exterior walls, such as where an exterior show wall forms an exterior wall of a building, various exterior finishes can be applied or adhered directly to the exposed surfaces of lightweight composite panels without the need for lath or other underlying layers.

Lightweight composite panels include a strong, yet lightweight, foam core sandwiched between relatively thin fiber mesh reinforced cementitious (or other protective) layers. As a result, the lightweight composite panels are strong and can support relatively heavy loads, such as multiple layers of stucco finish, brick veneers, stone, masonry, interior or exterior molding, tiles, light fixtures, and other fixtures using nails, other hangers, construction adhesive, or other wall attachment systems. The lightweight composite panels are lightweight yet waterproof, heat resistant, and fire resistant, and have high structural strength (i.e., high tensile and flexural strength and high toughness). The lightweight composite panels can be cut, drilled, and screwed, fastened and/or glued onto structural elements of buildings, such as studs and sheathing, and shaft liner frame. The interior-facing fiber mesh reinforced cementitious layer can provide a bonding surface that facilitates adhesion of lightweight composite panels to an adjacent wall structure or shaft liner frame.

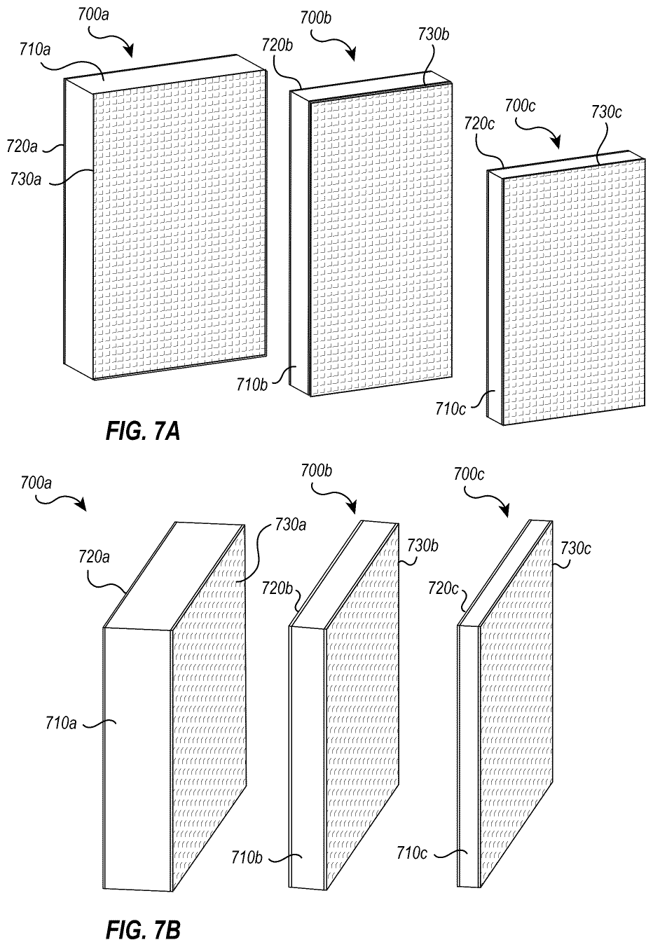

Additional information regarding lightweight composite panels is set forth in a later section below, including disclosure relating to FIGS. 7A-14. Lightweight composite panels are capable of providing protection against fire because they do not burn. In the case where the foam core is a polymer foam, particularly when treated with a fireproofing material, the polymer foam core may melt, but it will not burn. In the case where the foam core is an inorganic foam, particularly a refractory foam material, perlite, or glass foam, the inorganic foam core may not even melt in order for the lightweight composite panels to maintain their structural integrity even when exposed to fire or intense heat.

### II. Methods and Systems for Constructing a Vertical Shaft Liner

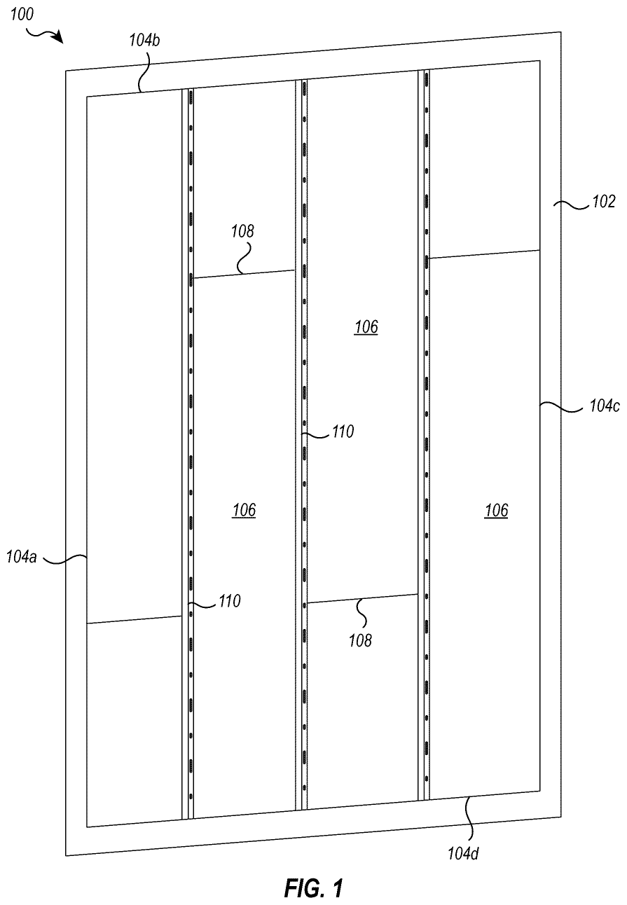

Reference is now made to FIGS. 1-5B, which illustrate embodiments of vertical shaft liners, components used to make vertical shaft liners, and vertical shaft liners in various stages of being constructed.

FIG. 1 illustrates an example of a main vertical shall wall 100 of a shaft liner that includes a shaft liner frame 102, horizontal and vertical tracks or runners 104a, 104b, 104c that make up the shaft liner frame 102, main lightweight composite panels 106 used to make vertical shaft wall columns which lie in the same plane, and vertical studs 110 that interconnect and help support the vertical shaft wall columns of the main vertical shall wall 100. In some cases, multiple lightweight composite panels 106 with butt joints 108 are used to make each vertical shaft wall column. The horizontal and vertical tracks or runners 104a, 104b, 104c include flanges and channels that hold the main lightweight composite panels 106 and vertical studs 110 in place within the shaft liner frame 102. The vertical studs 110 also include flanges and channels that interconnect and hold the vertical shaft wall columns securely in place within the shaft liner frame 102.

The shaft liner frame 102, including the horizontal and vertical tracks or runners 104a, 104b, 104c and also the vertical studs 110, are advantageously made of metal (e.g., galvanized or stainless steel) to provide high strength for holding or retaining the main vertical shaft wall in place, to be fireproof, and resist water damage. The main lightweight composite panels 106 are heat and moisture resistant and non-combustible so as to not burn if exposed to fire.

In order to provide a high degree of heat and moisture resistance, the main lightweight composite panels 106 used to make the main vertical shaft walls are advantageously thicker than auxiliary shaft liner walls (not shown) fastened to the shaft liner frame. In some embodiments, main the lightweight composite panels 106 used to make the main vertical shaft walls can have a thickness of about ¾ inch to about 1½ inch, or about ⅞ inch to about 1¼ inch, or about 1 inch. In some embodiments, lightweight composite panels or gypsum boards used to auxiliary shaft liner walls and show walls can have a thickness of about ⅜ inch to about ⅝ inch, or about 7/16 inch to about 9/16 inch, or about ½ inch.

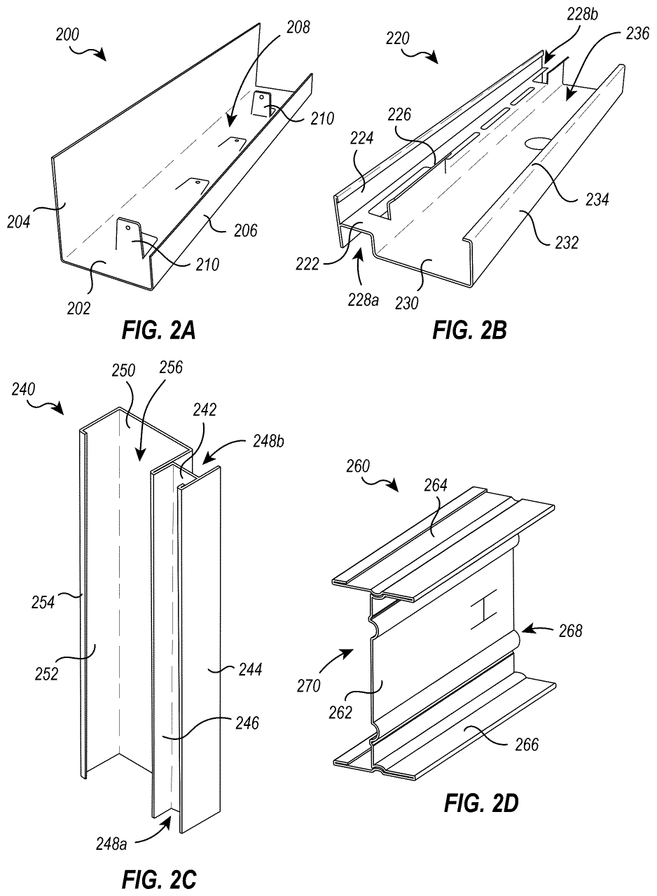

FIGS. 2A-2D illustrate embodiments of metal structural elements used to make shaft liner frames and main and auxiliary vertical shaft walls according to the disclosure.

FIG. 2A illustrates an example J-track or J-runner 200 that can be used to construct a three-dimensional shaft liner frame, including upper and lower horizontal tracks or runners and one or more vertical tracks or runners. The J-track or J-runner 200 is advantageously made of metal, such as galvanized or stainless steel. The J-track or J-runner 200 includes a main wall 202, a first longer sidewall 204, a second shorter sidewall 206, and a main channel 208 between the first and second sidewalls 204, 206. Inwardly facing tabs 210 formed in the channel 208 are used to create a subchannel having a width that corresponds to the thickness of main lightweight composite panels used to form the main vertical shaft wall. In this way, the main lightweight composite panels used to form the main vertical shaft wall can be held in place (e.g., in a friction fit) within the subchannel between the first longer sidewall 204 and the tabs 210.

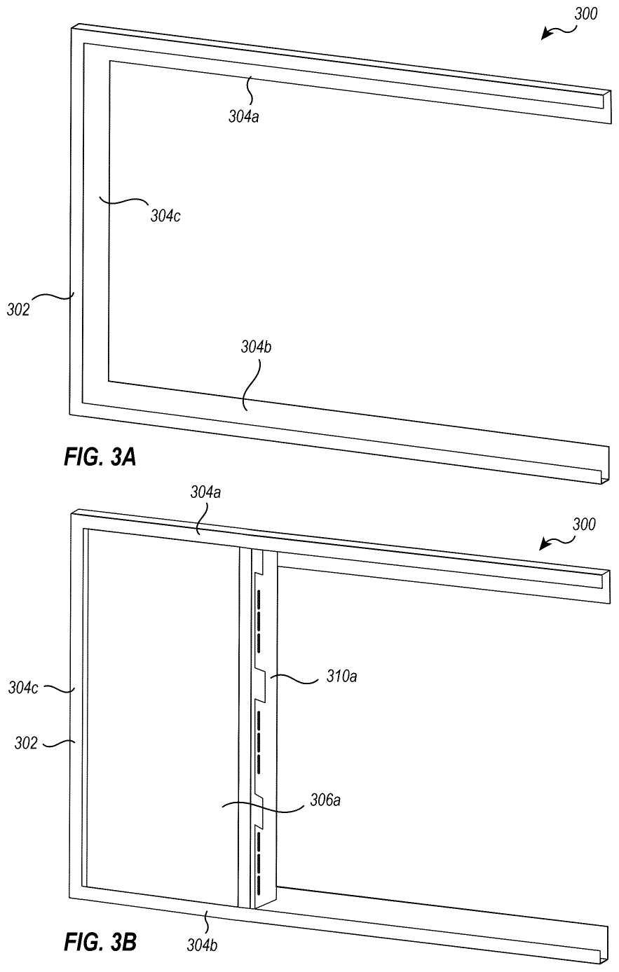

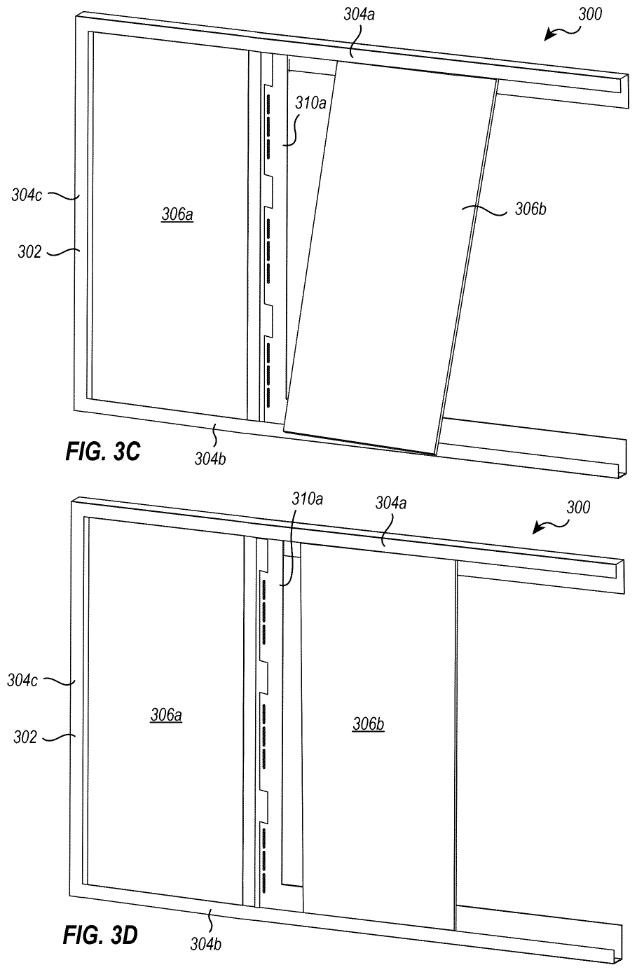

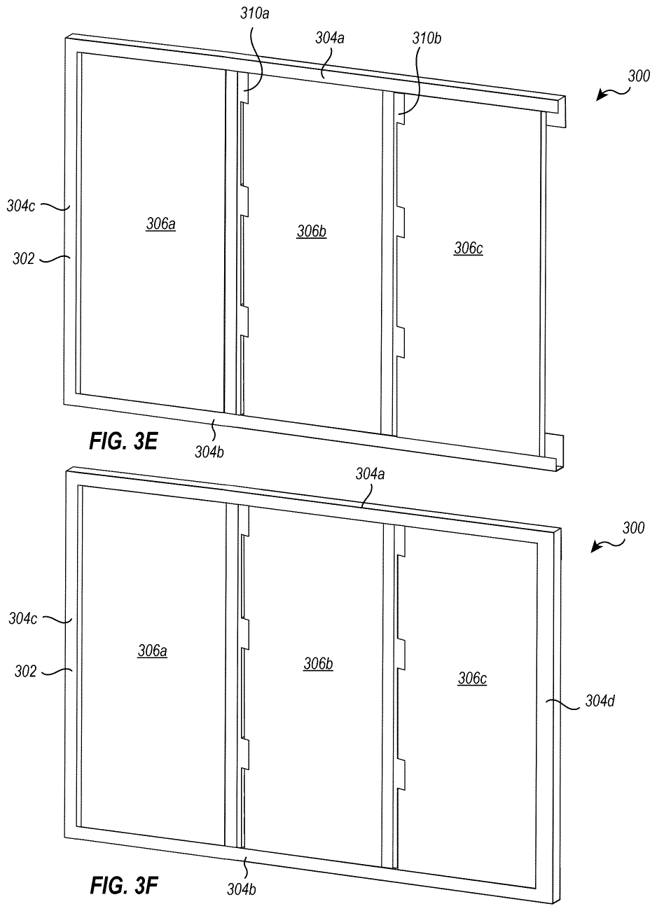

The main wall 202 can be used to fasten the J-track or J-runner 200 to a beam or ceiling structure (e.g., using screws, rivets, adhesive, or other fastening means) to form an upper horizontal track or runner of a shaft liner frame, to a floor or other structure to form a lower horizontal track or runner of a shaft liner frame, and to a wall or other structure to form a vertical side track or runner of a shaft liner frame. The second shorter sidewall 206 can function to retain a vertical stud (see FIG. 3B) placed within the main channel 208 of the J-track or J-runner 200 forming the shaft liner frame. The second shorter sidewall 206 can also provide a flange to which one or more exterior auxiliary walls can be fastened (e.g., using screws, rivets, adhesives, or other fastening means). The first longer sidewall 204 functions to retain a vertical shaft wall in place within the subchannel and can also provide a flange to which an interior auxiliary wall (e.g., show wall) can be fastened adjacent to the main vertical shaft wall (e.g., using screws, rivets, adhesives, or other fastening means). The first longer sidewall 204 can also function as a flange to which main lightweight composite panels used to make the main vertical shaft wall can be more securely fastened (e.g., using screws, rivets, adhesives, or other fastening means). The first longer sidewall 204 can also function as a flange to fasten vertical side tracks or runners to upper and lower horizonal tracks or runners (e.g., using screws, rivets, adhesives, or other fastening means).

FIG. 2B illustrates an example C-T stud 220 that can be used to interconnect vertical shaft wall columns when constructing a main vertical shaft wall (see FIGS. 1 and 3B-3F). The C-T stud 220 is advantageously made of metal, such as galvanized or stainless steel. The “T” portion of the C-T stud 220 includes a main wall 222, an outer wall 224 at an outer end of the main wall 222, an inner wall 226 at an inner end of the main wall 222, and first and second channels 228a, 228b formed by the main wall 222, outer wall 224, and inner wall 226. The channels 228 can have a width that corresponds to the thickness of main lightweight composite panels used to form adjacent vertical shaft wall columns. In this way, the main lightweight composite panels used to form first and second adjacent vertical shaft wall columns can be held in place (e.g., in a friction fit) within the first and second channels 228a, 228b between the outer wall 224 and the inner wall 226, with the main wall 222 being positioned between and abutting adjacent vertical shaft wall columns received within the channels 228.

The “C” portion of the C-T stud 220 includes a main connecting wall 230, an outer wall 232, an inward-facing lip 234 extending laterally from an end of the outer wall 232, and a channel 236 formed by the main connecting wall 230, the inner wall 226 of the “T” portion of the C-T stud 220, and the outer wall 232. The channel 236 may remain empty or it may be filled with insulation or other material if desired. The outer wall 224 of the “T” portion of the C-T stud 220 and the outer wall 232 of the “C” portion of the C-T stud 220 can abut corresponding inner surfaces of the first and second sidewalls 204, 206 of upper and lower J-tracks or J-runners 200 of a shaft liner frame in order to retain the top and bottom ends of the C-T stud 220 within the shaft liner frame.

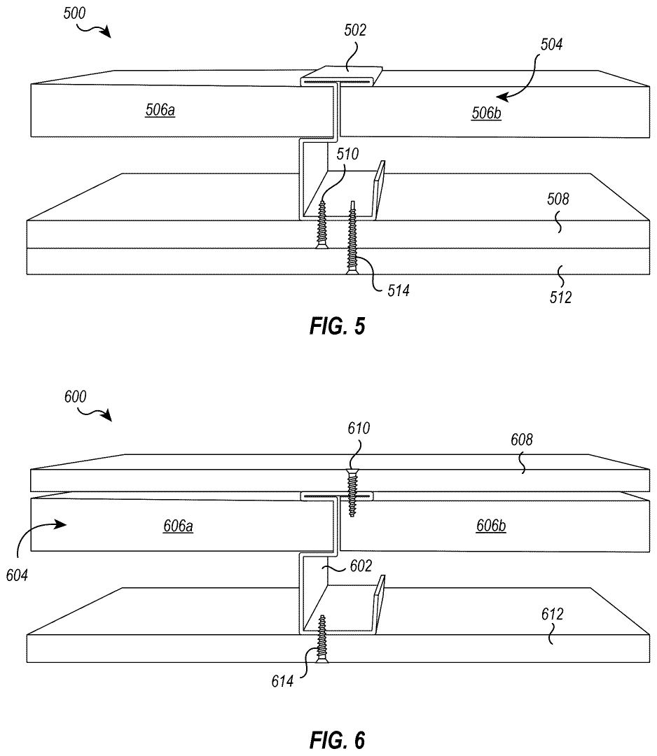

The outer wall 232 of the “C” portion of the C-T stud 220 can provide a flange to which one or more auxiliary vertical walls, including an exterior show wall (see FIGS. 5 and 6) can be fastened (e.g., using screws, rivets, adhesives, or other fastening means). The outer wall 224 of the “T” portion of the C-T stud 220 can provide a flange to which an auxiliary wall (e.g., interior show wall) (see FIG. 6) can be fastened (e.g., using screws, rivets, adhesives, or other fastening means). In some embodiments, the C-T stud 220 can be fastened to the upper and lower J-tracks or J-runners 200 of a shaft liner frame using screws, rivets, adhesives, or other fastening means to create a stronger vertical shaft liner.

FIG. 2C illustrates an example C-H stud 240 that can be used to interconnect vertical shaft wall columns when constructing a main vertical shaft wall (see FIGS. 1 and 3B-3F). The C-H stud 240 is advantageously made of metal, such as galvanized or stainless steel, and is substantially similar to the C-T stud 220 of FIG. 2B. The main difference is that the inner wall 246 forming the “H” portion of the C-H stud 240 is continuous rather than having a recessed portion as in the inner wall 226 forming the “T” portion of the C-T stud 220. Thus, the “H” portion of the C-H stud 240 includes a main wall 242, an outer wall 244 at an outer end of the main wall 242, an inner wall 246 at an inner end of the main wall 242, and first and second channels 248a, 248b formed by the main wall 242, outer wall 244, and inner wall 246. The channels 248 can have a width that corresponds to the thickness of main lightweight composite panels used to form adjacent vertical shaft wall columns. In this way, the main lightweight composite panels used to form first and second adjacent vertical shaft wall columns can be held in place (e.g., in a friction fit) within the first and second channels 248a, 248b between the outer wall 244 and the inner wall 246, with the main wall 242 being positioned between and abutting adjacent vertical shaft wall columns received within the channels 248.

The “C” portion of the C-H stud 240 includes a main connecting wall 250, an outer wall 252, an inward-facing lip 254 extending laterally from an end of the outer wall 252, and a channel 256 formed by the main connecting wall 250, the inner wall 246 of the “H” portion of the C-H stud 240, and the outer wall 252. The channel 256 may remain empty or it may be filled with insulation or other material if desired. The outer wall 244 of the “H” portion of the C-H stud 240 and the outer wall 252 of the “C” portion of the C-H stud 240 can abut corresponding inner surfaces of the first and second sidewalls 204, 206 of upper and lower J-tracks or J-runners 200 of a shaft liner frame in order to retain the top and bottom ends of the C-H stud 240 within the shaft liner frame.

The outer wall 252 of the “C” portion of the C-H stud 240 can provide a flange to which one or more auxiliary vertical walls, including an exterior show wall (see FIGS. 5 and 6) can be fastened (e.g., using screws, rivets, adhesives, or other fastening means). The outer wall 244 of the “H” portion of the C-H stud 240 can provide a flange to which an auxiliary wall (e.g., interior show wall) (see FIG. 6) can be fastened (e.g., using screws, rivets, adhesives, or other fastening means). In some embodiments, the C-H stud 240 can be fastened to the upper and lower J-tracks or J-runners 200 of a shaft liner frame using screws, rivets, adhesives, or other fastening means to create a stronger vertical shaft liner.

FIG. 2D illustrates an example I-stud 260 that can be used to interconnect vertical shaft wall columns when constructing a vertical shaft wall. The I-stud 260 is advantageously made of metal, such as galvanized or stainless steel. The I-stud 260 includes a main wall 262, an inner wall 264 at a first end of the main wall 262, an outer wall 266 at a second end of the main wall 262, and first and second channels 268, 270 between the inner wall 264 and the outer wall 266 on either side of the main wall 262. The I-stud 260 is simpler in design and less specialized and somewhat less functional than the C-T stud 220 of FIG. 2B and the C-H stud 240 of FIG. 2C. That is because the I-stud 260 lacks a “T” or “H” portion with subchannels for receiving therein main lightweight composite panels used to make adjacent vertical shaft wall columns. As a result, it may be desirable or necessary to fasten main lightweight composite panels used to make vertical shaft wall columns to the inner wall 264 of the I-stud 260 using screws, rivets, adhesives, or other fastening means, with a portion of the main wall 262 being positioned between and abutting adjacent vertical shaft wall columns received within the channels 268, 270.

The empty portion of channels 268, 270 may remain empty or they may be filled with insulation or other material if desired. The inner wall 264 and the outer wall 266 of the I-stud 260 can abut corresponding inner surfaces of the first and second sidewalls 204, 206 of upper and lower J-tracks or J-runners 200 of a shaft liner frame in order to retain the top and bottom ends of the I-stud 260 within the shaft liner frame. The outer wall 266 can provide a flange to which one or more auxiliary vertical walls, including an exterior show wall (see FIGS. 5 and 6) can be fastened (e.g., using screws, rivets, adhesives, or other fastening means). The inner wall 264 can provide a flange to which an auxiliary wall (e.g., interior show wall) (see FIG. 6) can be fastened (e.g., using screws, rivets, adhesives, or other fastening means). In some embodiments, the I-stud 260 can be fastened to the upper and lower J-tracks or J-runners 200 of a shaft liner frame using screws, rivets, adhesives, or other fastening means to create a stronger vertical shaft liner.

FIGS. 3A-3F illustrate the construction of a main vertical shaft wall 300.

FIG. 3A illustrates a partially constructed shaft liner frame 302 made using J-tracks or J-runners and that includes an upper horizontal track or runner 304a, a lower horizontal track or runner 304b, and a vertical side track or runner 304c.

FIG. 3B illustrates a shaft liner frame 302 into which have been placed one or more main lightweight composite panels to form a first vertical shaft wall column 306a and a first vertical stud 310a. The upper end of the first vertical shaft wall column 306a is positioned within a down-facing channel of the upper track or runner 304a; the bottom end of the first vertical shaft wall column 306a is positioned within an up-facing channel of the lower track or runner 304b; a first side of the first vertical shaft wall column 306a is positioned within a side-facing channel of the vertical side track or runner 304c; and a second side of the first vertical shaft wall column 306a is positioned within a side-facing channel of the first vertical stud 310a. The first vertical shaft wall column 306a can be held in place within the channels via friction fit and/or by fasteners or adhesives known in the art.

FIG. 3C illustrates the partially constructed main vertical shaft wall 300 of FIG. 3B with a second vertical shaft wall column 306b made from one or more main lightweight composite panels being inserted into an upper channel of the upper track or runner 304a.

FIG. 3D illustrates the partially constructed main vertical shaft wall 300 of FIGS. 3B and 3C with the second vertical shaft wall column 306b having been inserted into a lower channel of the lower track or runner 304b prior to moving the second vertical shaft wall column 306b toward the first vertical stud 310a.

FIG. 3E illustrates the partially constructed main vertical shaft wall 300 of FIGS. 3B-3D with three vertical shaft wall columns 306a, 306b, 306c having been inserted into the shaft liner frame 302 and interconnected by first and second vertical studs 310a, 310b. The first vertical stud 310a is positioned between first and second vertical shaft wall columns 306a, 306b, and the second vertical stud 310b is positioned between second and third vertical shaft wall columns 306b, 306c.

FIG. 3F illustrates a main vertical shaft wall 300 comprising a shaft liner frame 302 that forms a perimeter around all four sides of the main vertical shaft wall 300, including around the three vertical shaft wall columns 306 and two vertical studs 310. It will be readily understood that a complete shaft liner can be constructed using four main vertical shaft walls 300, with each main vertical shaft wall 300 being oriented at an angle (e.g., 90° angle) relative to adjacent main vertical shaft walls 300 so that the main vertical shaft walls at least partially enclose all four sides of a vertical shaft.

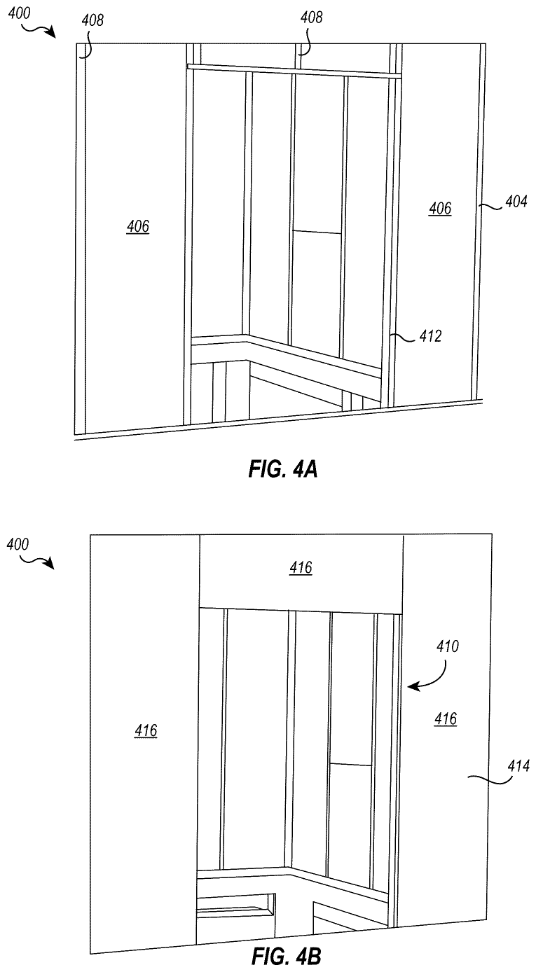

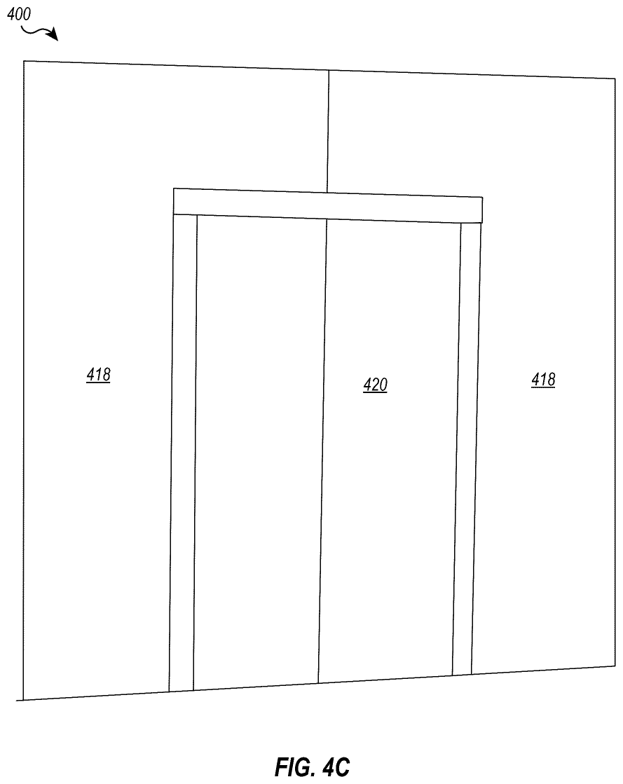

FIG. 4A illustrates an example elevator shaft liner 400 with a plurality of main vertical shaft walls formed using a three-dimensional shaft liner frame 404 made using horizontal and vertical tracks or runners, a plurality of vertical shaft wall columns 406 made using main lightweight composite panels positioned in the shaft liner frame 404 and interconnected by vertical studs 408, and an elevator door opening 410 with a door frame 412 made using horizontal and vertical tracks or runners that are the same as or similar to those used to make the shaft liner frame 404.

FIG. 4B illustrates the elevator shaft liner 400 of FIG. 4A with an auxiliary vertical wall 414 made using a plurality of lightweight composite panels and/or gypsum boards 416 fastened to an exterior side of the shaft liner frame 404 and door frame 412 using fastening means known in the art.

FIG. 4C illustrates the elevator shaft liner 400 of FIGS. 4A and 4B with a show wall 418 made using a plurality of lightweight composite panels and/or gypsum boards placed over the auxiliary vertical wall 414 of FIG. 4B and fastened to the exterior side of the shaft liner frame and door frame using fastening means known in the art, and an elevator door 420 having been installed within the door frame 412.

FIG. 5 illustrates an example configuration of a vertical shaft liner 500 for an elevator shaft, including a C-T stud 502, a main vertical shaft wall 504 formed by a pair of vertical shaft wall columns 506a, 506b made using main lightweight composite panels (e.g., about 1 inch thick) interconnected by the C-T stud 502, a first interior auxiliary vertical wall 508 fastened to a side of the C-T or C-H stud 502 opposite the vertical shaft wall 504 using first screws 510, and a second or exterior auxiliary vertical wall (e.g., exterior show wall) 512 fastened to the C-T or C-H stud 502 adjacent to the underlying or auxiliary vertical wall 508 using second screws 514. The first and second auxiliary vertical walls 508, 512 can be made from lightweight composite panels.

FIG. 6 illustrates an example configuration of a vertical shaft liner 600 for a stairwell shaft, including a C-T stud 602, a main vertical shaft wall 604 formed by a pair of vertical shaft wall columns 606a, 606b made using main lightweight composite panels (e.g., about 1 inch thick) interconnected by the C-T stud 602, a first auxiliary wall (e.g., interior show wall) 608 fastened to the C-T stud 602 adjacent to the main vertical shaft wall 604 using first screws 610, and a second auxiliary wall (e.g., exterior show wall) 612 fastened to a side of the C-T stud 602 opposite the main vertical shaft wall 604 using second screws 614. The first and second auxiliary vertical walls 608, 612 can be made from lightweight composite panels.

It is also within the scope of the disclosure to utilize conventional gypsum boards to construct auxiliary vertical walls (e.g., show walls) of shaft liners. Gypsum boards can provide a high degree of fire and heat resistance and, although they are generally heavier than the lightweight composite panels disclosed herein, they are generally thinner than the much heavier gypsum boards used to make the main vertical shaft walls, which are typically 1 inch thick, and therefore more manageable in terms of weight and ease of installation.

In order to provide a high degree of heat and moisture resistance, the main lightweight composite panels used to make the main vertical shaft walls 504 and 604 of FIGS. 5 and 6 advantageously have a thickness of about ¾ inch to about 1½ inch, or about ⅞ inch to about 1¼ inch, or about 1 inch. For ease of installation and to provide additional heat and moisture resistance to the overall shaft liners 500 and 690 of FIGS. 5 and 6, the lightweight composite panels (and/or gypsum boards) used to make the auxiliary vertical walls 508, 512, 608, 612 in FIGS. 5 and 6 advantageously have a thickness of about ⅜ inch to about ⅝ inch, or about 7/16 inch to about 9/16 inch, or about ½ inch.

### III. Lightweight Composite Panels

The shaft liners disclosed herein are made using one or more layers of lightweight composite panels positioned within or fastened to the shaft liner frame. Lightweight composite panels can be used to make main vertical shaft walls, vertical show walls (interior and exterior), and auxiliary vertical walls (e.g., positioned between the shaft liner frame and a show wall). Lightweight composite panels comprise a strong, yet lightweight, polymer or inorganic foam core and layers of fiber mesh reinforced cementitious composition (or other protective layer) on opposite sides of the foam core. As a result, the lightweight composite panels are strong and can support relatively heavy loads.

### A. Core Structure and Manufacture of Lightweight Composite Panels

FIGS. 7A and 7B illustrate examples of lightweight composite panels 700a, 700b, 700c of varying cross-sectional thickness that can be used as is or modified with other features for a specific purpose. FIGS. 7A and 7B show the layered structure of the lightweight composite panels 700a, 700b, 700c, including strong, lightweight, and moisture-resistant extruded polystyrene (XPS) foam cores 710a, 710b, 710c sandwiched between first fiber mesh reinforced cementitious layers 720a, 720b, 720c and second fiber mesh reinforced cementitious layers 730a, 730b, 730c. As discussed below, in other embodiments the foam core may comprise other polymer or inorganic foam materials, and one or both protective layers may comprise a thermoset polymer or other rigid protective material.

The cross-sectional thickness of lightweight composite panels 700a, 700b, 700c can be selected based on a combination of desired properties for their intended use, such as strength, insulation, spacing between wall elements, and the like. As illustrated in FIGS. 7A and 7B, the cross-sectional thicknesses of the lightweight composite panels 700a, 700b, 700c varies mostly or entirely depending on the cross-sectional thickness of the foam cores 710a, 710b, 710c. Although not shown, when lightweight composite panels 700 of greater cross-sectional thickness are desired, it may be desirable to increase the thickness of the fiber mesh reinforced cementitious layers 720, 730 (e.g., to account for possible strength reduction caused by including a foam core 710 of greater cross-sectional thickness). The foam cores 710a, 710b, 710c can be a lightweight polymer foam made from closed cell extruded polystyrene (XPS), is lightweight, rigid, waterproof, thermally insulating, and includes two outer surfaces or faces. In some embodiments, the foam cores 710 a, 710b, 710c may have a density of about 30-45 kg/m³ and a compressive strength of about 250-400 kPa.

Alternatively, the foam cores 710, 710a, 710b, 710c discussed above can be made from a different polymer foam material, such as, but not limited to, expanded polystyrene foam (EPS), polyisocyanurate foam, polyurethane (PUR) foam, phenolic polymer (e.g., phenol-formaldehyde) foam, melamine polymer (e.g., melamine-formaldehyde) foam, and/or other thermoplastic or thermoset polymer known in the art that can be formed into rigid or semi-rigid foam layers. An advantage of thermoset polymer foam materials is they are generally more fire- and heat-resistant than thermoplastic polymers, with thermoset phenolic polymers in particular providing a high level of fire and heat resistance.

The properties of various polymers that can be used to make foam core layers 110, 210 are set forth in Tables 1-3.

TABLE 1

| Property | XPS/EPS | Phenolic | |
|---|---|---|---|
| Material Type | Thermoplastic | Thermoset (phenol- | |
| | polystyrene | formaldehyde) | |
| Thermal Conductivity (W/m · K) | 0.028-0.033 | 0.018-0.022 | |
| R-Value per inch | ~5.0 | 6.5-7.2 | |
| Fire Resistance | Poor - melts, drips | Excellent - chars, low | |
| | | smoke | |
| Flame Spread (ASTM E84) (W/O Facer | 75-200 | <25 (Class A) | |
| Smoke Development (W/O Facer) | >450 (often) | <50 | |
| Thermal Stability | ~93° C. (melts) | 150-175° | C. |
| Water Resistance | Excellent | Good (closed-cell) | |
| Compressive Strength | 200-300 kPa | 100-150 | kPa |

| | | |
|---|---|---|
| Flexural Strength | Flexible, good | Brittle |
| Recyclability | Yes (thermoplastic) | No |
| Weight (kg/m³) | 25-35 | 35-50 |
| Cost | Low-Moderate | High |

TABLE 2

| Property | Melamine | PUR | |
|---|---|---|---|
| Material Type | Thermoset (melamine- | Thermoset (polyol + | |
| | formaldehyde) | isocyanate) | |
| Thermal Conductivity (W/m · K) | 0.032-0.036 | 0.020-0.025 | |
| R-Value per inch | ~4.1-4.5 | ~6.0-6.5 | |
| Fire Resistance | Excellent - non- | Poor - needs FR | |
| | melting, self- | additives | |
| | extinguishing | | |
| Flame Spread (ASTM E84) (W/O Facer | <25 (Class A) | Varies (often >25) | |
| Smoke Development (W/O Facer) | Very low | High | |
| Thermal Stability | ~240° C. | ~100-120° | C. |
| Water Resistance | Poor unless sealed | Good | |
| Compressive Strength | Low | 150-300 | kPa |

| | | |
|---|---|---|
| Flexural Strength | Very brittle | Strong |
| Recyclability | Limited | No |
| Weight (kg/m³) | 7-12 | 30-45 |
| Cost | High | Moderate |

TABLE 3

| Property | Polyiso | |
|---|---|---|
| Material Type | Thermoset (polyisocyanurate) | |
| Thermal Conductivity (W/m · K) | 0.020-0.023 | |
| R-Value per inch | ~6.0-6.5 | |
| Fire Resistance | Good - chars, often Class A | |
| | with facer | |
| Flame Spread (ASTM E84) (W/O Facer | <25 (Class A with facer) | |
| Smoke Development (W/O Facer) | <150 | |
| Thermal Stability | ~150° | C. |
| Water Resistance | Fair (can degrade if | |
| | unprotected) | |
| Compressive Strength | 140-200 | kPa |

| | |
|---|---|
| Flexural Strength | Moderate |
| Recyclability | Rarely recycled |
| Weight (kg/m³) | 30-42 |
| Cost | Moderate-High |

With reference to FIGS. 7A-7B, formed over first and second outer surfaces of the foam core 710 are first and second layers of fiber (e.g., fiberglass) mesh (not shown), which become embedded within respective first and second layers of fresh cementitious composition applied over the fiber mesh layers, which harden or cure to form first and second cementitious layers. Together, the hardened cementitious layers and embedded fiberglass mesh layers form the first and second fiber mesh reinforced cementitious layers 720, 730, which adhere to the foam core 710 to form a strong but lightweight composite panel structure. The fiber mesh layers can alternatively include other fibers or filaments, such as carbon fibers or filaments.

The lightweight foam core is typically made from extruded polystyrene foam (XPS), but can alternately comprise expanded polystyrene foam (EPS), polyisocyanurate foam, polyurethane (PUR) foam, phenolic polymer (e.g., phenol-formaldehyde) foam, melamine polymer (e.g., melamine-formaldehyde) foam, and/or other thermoplastic or thermoset polymer known in the art that can be formed into rigid or semi-rigid foam layers. The lightweight foam core can be made of closed cell polystyrene foam to provide a water-resistant barrier (e.g., 100% waterproof).

Alternatively, the foam core may comprise an inorganic foam, such as a refractory foam material, to provide additional fire-resistance. Examples include expanded perlite (e.g., expanded spheres or microspheres), vermiculite, pumice, ceramic microspheres, hollow glass spheres, glass foam, ceramic foam, expanded silica gel, aerogel, other silicate foams, porous wollastonite, metakaolin, urea-silicate foam, SiOC/SiC foam, refractory foams, graphene, and the like. The inorganic foam core can resist melting even when exposed to fire or intense heat in order for the lightweight composite panel to maintain its structural integrity. The inorganic foam core may include optional reinforcement fibers (cellulosic, basalt, E-glass, or carbon), and optional additives including hydrophobes, biocides, and phase-change or intumescent materials.

In some embodiments, the inorganic foam core is made from a moldable inorganic material that can be formed into inorganic foam sheets or boards. For example, inorganic particles such as expanded perlite, vermiculite, foamed glass particles, pumice, ceramic microspheres expanded silica gel, other inorganic foam particles, and combinations thereof can be blended with a binder material and formed into sheets. In some embodiments, a multi-binder matrix can be formed from one or more of: (i) sodium or potassium silicate solution; (ii) reactive siloxane or organosilane resin; (iii) geopolymeric aluminosilicate binder; (iv) magnesium oxide; (v) urea and polyurea; (vi) hydraulic binder or latent hydraulic setting agents, including calcium aluminate, calcium silicate, magnesium oxychloride, magnesium phosphate, or calcium sulfate hemihydrate; or (vii) bitumen (which provides high hydrophobicity and water resistance, e.g., <0.1% water absorption).

In some embodiments, a mixture of inorganic particles and silicate binder solution, such as an alkali silicate solution (e.g., sodium silicate and/or potassium silicate), optionally in combination with magnesium oxide, a reactive siloxane or organosilane resin and/or with other binder system disclosed herein, are formed into extruded or molded sheets or boards and caused or allowed to dry and cure (e.g., by forming bonds between the inorganic particles and binder materials). The binder network is typically formed through one or more curing mechanisms-such as dehydration, condensation, carbonation, or crosslinking-depending on composition.

Alternatively, the inorganic particles can be mixed with an organic binder, such as a thermoplastic polymer or thermoset resin, and formed into a sheet, which is then allowed to harden by cooling or thermoset curing. Example organic binders include, but are not limited to, polystyrene, polyisocyanurate polyurethane, phenolic polymers (e.g., phenol-formaldehyde), melamine polymers (e.g., melamine-formaldehyde), urethane foam made from methylene diphenol diisocyanate (MDI), polyolefins, polyesters, polyamides, polyether ether ketones (PEEK), (meth)acrylates, polycarbonates, and/or other thermoplastic and thermoset polymers known in the art.

In some embodiments, the inorganic foam core of lightweight composite panels is manufactured by blending one or more inorganic particles as disclosed herein with a binder system to form a moldable material, forming the moldable material into a sheet, causing or allowing the binder system to solidify to form an inorganic foam core.

In some embodiments, lightweight composite panels are manufactured by applying a fiber (e.g., fiberglass) mesh and cementitious or curable resin composition onto at least one surface of the inorganic foam core and causing or allowing the cementitious or curable resin composition to harden. The fiber mesh can be embedded in the cementitious or curable resin composition to enhance strength, increase toughness, and prevent cracking. In some embodiments, a fresh cementitious composition comprises mixture products of hydraulic cement, silicon dioxide powder, calcium oxide, iron oxide, plaster of Paris (gypsum hemihydrate), water-reducing agent, defoamer, styrene, and acrylic acid. The hydraulic cement typically includes Portland cement, but may also include supplementary cementitious materials (SCMs), such as ground granulated blast furnace slag (GGBFS), fly ash, natural pozzolan, silica fume, microsilica, metakaoline, ground glass, calcined clay, finely ground quartz, and the like. The fresh cementitious composition may include other components, such as natural hydraulic lime, calcium silicate, and/or expanded glass, which can increase fire and heat resistance.

The layers of fiber mesh reinforced cementitious composition are generally “thin” (e.g., typically less than about 3 mm, less than about 2.5 mm, less than about 2 mm, or less than about 1.5 mm, such as about 1 mm, or between about 0.5-3 mm, about 0.75-2.5 mm, or about 1-2 mm in cross-sectional thickness). The fiber mesh reinforced cementitious layers can be very lightweight yet waterproof and have high structural strength (i.e., high tensile and flexural strength and high toughness). The fiber mesh component is typically fiberglass fiber or glass filament mesh, but can be made of other strong fibers or filaments, such as carbon fibers or filaments. In some embodiments, fiberglass mesh is formed of an alkali-resistant material and may have nominal mesh size of 4×4 mm with a strand diameter of about 0.5-1.0 mm.

In some embodiments, the fresh cementitious composition comprises mixture products of water, hydraulic cement, silicon dioxide powder, calcium oxide, iron oxide, plaster of Paris (gypsum hemihydrate), water-reducing agent, defoamer, styrene, and acrylic acid. The fresh cementitious composition may optionally include supplementary cementitious materials (SCMs), such as ground granulated blast furnace slag (GGBFS), fly ash, natural pozzolan, silica fume, microsilica, metakaoline, ground glass, calcined clay, finely ground quartz, limestone powder, and the like. The cementitious composition may include other components, such as natural hydraulic lime, calcium silicate, and/or expanded glass, which can increase fire and heat resistance.

In the case where it is desired for lightweight composite panels to have beveled edges (e.g., to accommodate mesh tape and wall patch to join adjacent lightweight composite panels together), the fiber mesh reinforced cementitious layer can be applied before or after forming beveled edges in the form core, preferably after forming beveled edges to create a continuous fiber mesh reinforced cementitious layer across the entire surface of the lightweight composite panel.

In a more particular embodiment, the cementitious composition applied to the outer surfaces of the foam core to form fiber mesh reinforced cementitious layers of the lightweight composite panels can be formed by mixing together the following components (expressed in weight percent) to form a fresh flowable cementitious composition, which is applied to the foam core surfaces, together with fiber mesh, and then allowed to harden or cure:

| | |
|---|---|
| Hydraulic cement | 30-50% |
| Silicon dioxide | 40-60% |
| Calcium oxide | 2-5% |
| Iron oxide | 0.2-1% |
| Gypsum hemihydrate | 3-8% |
| Water-reducing agent | 0.2-0.6% |
| Defoamer | 0.2-0.6% |
| Styrene | 1-2% |
| Acrylic acid | 1-2% |
| Water | (16-20%, preferably 18.4% of |
| | dry ingredients above) |

The hydraulic cement typically includes Portland cement clinker interground with gypsum for set control, but may also include other interground minerals, such as limestone filler (e.g., 5-10% by weight of the hydraulic cement), and optionally one or more supplementary cementitious materials (SCMs), such as ground granulated blast furnace slag (GGBFS), fly ash, natural pozzolan, silica fume, microsilica, metakaoline, ground glass, calcined clay, finely ground quartz, and the like. The silicon dioxide can be 150 mesh ground quartz sand. The water reducer can be a low-range water reducer, such as a compound of carboxylic acid grafted multi-polymer and other effective additives. The defoamer can reduce the surface tension of water, solution, suspension, etc., prevent the formation of foam, or reduce or eliminate the original foam. The main component of the defoamer can be polydimethylsiloxane (MesSiO(Me₂SiO)nSiMe₃) (Me=methyl). In the case where very fine SCMs (e.g., silica fume, microsilica, or metakaoline), it may be desirable to use a high range water reducer (e.g., polycarboxylate ether) to obtain good flow. The styrene and acrylic acid components, which may be a copolymer, can form a chemical bond to the extruded polystyrene foam core, in addition to the physical bond.

The components of the cementitious composition can be mixed by high-performance mixing equipment through precise batching, and then fed into a mixing barrel in sequence for high-speed dispersion and mixing, thus yielding a fresh cementitious mixture. The fresh cementitious mixture is blended in a tank to make it into liquid or plastic form. The liquid cementitious mixture is then pumped into a machine variously called a “waterfall machine,” commonly known as a “curtain coater” or enrobing “coater/machine”, which has flow control of the liquid cementitious mixture and which will apply the liquid cementitious mixture onto surfaces of an extruded polystyrene foam sheet or other material to be coated. The liquid cementitious mixture is applied like a waterfall or curtain through a blade applicator to evenly apply it to the polymer foam surfaces or other surface to be coated. The product is then cured and left to stand for approximately 7 days as usual practice. However, if ambient conditions are dry and hot, the curing period could be shortened to approximately 3-4 days.

In general, the hardened fiber mesh reinforced cementitious composition can adhere and bond strongly to the polymer or inorganic foam core to form a strong lightweight composite panel structure that does not delaminate. The bond between the cementitious layers and the foam layer is likely a combination of physical and chemical interactions. When applied to the polymer or inorganic foam layer, the liquid cementitious composition can penetrate into surface pores of the foam layer, which upon hardening of the cementitious composition, forms a strong mechanical bond. This bond can be further enhanced through the inclusion of very fine pozzolans, such as silica fume, microsilica, or metakaoline on the cementitious composition, which creates a very high strength cementitious layer and are able to fill very small micropores. The polymer components of the cementitious composition may also interact with components of the foam layer to form a type of chemical bond between the cementitious layers and the foam (e.g., polymer) layer. Regardless of how bonding occurs, it is demonstrably very strong and does not delaminate during specified use. Curable resins also adhere and bond strongly to the foam core.

In some embodiments, when manufacturing the lightweight composite panel structure, the fiberglass mesh is first laid down on a polymer (e.g., extruded polystyrene) or inorganic foam sheet. A transportation belt then transports the foam sheet with the fiberglass mesh through the waterfall machine (commonly known as a “curtain coater” or enrobing “coater/machine”), which causes the liquid cementitious mixture to flow down like a waterfall or curtain, with control of the liquid cementitious mixture flow, onto the foam sheet or other substrate. In this way, the fiberglass mesh becomes embedded in the liquid cementitious mixture and essentially floats in the middle of the cementitious mixture. In other words, a portion of the liquid cementitious mixture will be positioned between the fiberglass mesh and the foam sheet in order to directly adhere to the foam sheet, and another portion of the liquid cementitious mixture will cover and encapsulate the fiber mesh to form the top surface of the lightweight composite panel structure. The result is a layered composite structure, with an interior polymer or inorganic foam sheet, an underlying layer of cementitious composition in direct contact with the foam sheet, a fiberglass mesh in the middle, and a top layer of cementitious composition covering the fiberglass mesh.

In addition to, or instead of, a fiber mesh reinformed cementitious layer, one or both protective layers of the lightweight composite panel may comprise other materials in addition to or instead of the cementitious composition. Examples include one or more of rigid magnesium oxide material, water-resistant polymer, or a composite material comprising a resin or polymer with embedded fibers, fiber mesh, fabric, scrim, felt, or non-woven. The material forming the fibers, fiber mesh, fabric, scrim, felt, or non-woven can be selected from plant fibers, polymer fibers, and inorganic fibers (e.g., basalt, rock wool, and the like). The resin or polymer may comprise a thermoplastic or thermoset material, such as UV-cured resins, polypropylene, polycarbonate, polyethylene terephthalate, polystyrene, acrylate, methacrylate, polyurea, polyaspartic, or epoxy. Protective layers of thermoset polymer can be slightly thicker than fiber mesh reinforced cementitious layers, such as between about 1-5 mm or about 2-3 mm.

Polyurea is a type of elastomer that is derived from the reaction product of an isocyanate component and an amine component. The isocyanate can be aromatic or aliphatic in nature. It can be monomer, polymer, or any variant reaction of isocyanates, quasi-prepolymer or a prepolymer. The prepolymer, or quasi-prepolymer, can be made of an amine-terminated polymer resin, or a hydroxyl-terminated polymer resin. The resin blend can include amine-terminated polymer resins and/or amine-terminated chain extenders. The resin blend may also contain additives or non-primary components, such as pigments pre-dispersed in a polyol carrier. Normally, the resin blend does not contain a catalyst. This is because the reaction between an isocyanate and amine is extremely fast and hence does not need catalysis.

The chemical structure of polyurea is as follows:

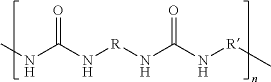

In a polyurea, alternating monomer units of isocyanates and amines react with each other to form urea linkages, as shown below.

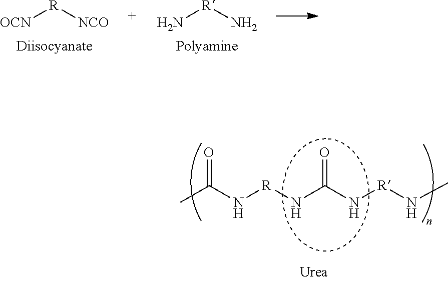

Polyaspartic resin is a solvent-free, aliphatic amine coating material based on aspartic acid, polyaspartic acid, or polyaspartic ester, which reacts with an isocyanate to create extremely durable protective coatings with rapid cure times, excellent abrasion resistance. An example of a curable polyaspartic resin has the following reactants and final cured polymer structure:

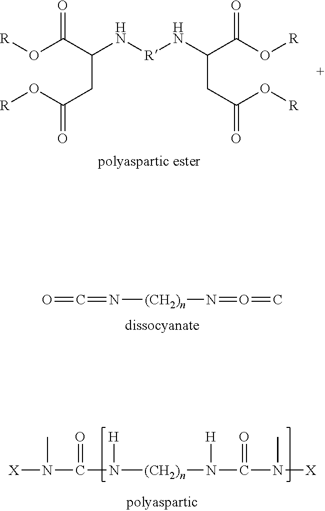

The curable resin can be applied by spray coating while in a flowable state to one or both surfaces of the foam core and allowing it to cure and form a solid protective layer. Multiple parts of the curable resin can be mixed just prior to entering or within the nozzle used to spray coat the foam core. Where it is desired to incorporate a fiberglass mesh sheet in the polymer layer, an initial coating of curable resin can be applied to the foam core, followed by applying the fiberglass mesh sheet over the resin, followed by applying a final coating of the curable resin.

In some embodiments, the outlines of the fiberglass mesh embedded within the hardened cementitious or cured resin layer can be visible and form a grid-like texture that improves adhesion of structural and/or decorative materials thereto, such as cementitious coatings, adhesives, paint, tiles, and the like. The textured surface provided by the fiber mesh reinforced cementitious layer can facilitate adhesion of lightweight composite panels to a shaft liner frame. In some embodiments, an appropriate adhesive, such as construction adhesive, can be used to adhere lightweight composite panels to a shaft liner frame, including studs or other structural elements, either in addition to or instead of screws or other mechanical fasteners. The use of adhesive attachment in addition to or instead of screws can eliminate discrete attachment points, creating a more solid and continuous bond that can better resist lateral forces and improve strength of the shaft liner.

The lightweight composite panels are typically rectangular in shape, with a constant cross-sectional thickness. Advantages of the lightweight composite panels include: being lightweight (i.e., approximately ⅓ the weight of gypsum drywall and approximately ⅙ the weight of cement board); 100% waterproof as a result of the core being high density closed cell foam; high strength, high thermal insulation (i.e., proving approximately 4 times greater insulation than gypsum drywall), adequate soundproofing, and textured outer layer ideal for applying cement and glue for additional products. Further, due to the two layers of fiber reinforced cementitious composition, one on each side, a nail or screw entering both external layers can hold significant weight, substantially more weight than gypsum board

The lightweight composite panels can be attached to the shaft liner frame as discussed above, either being positioned within channels of the shaft liner frame or fastened to the shaft liner frame using fasteners known in the art, such as screws, rivets, adhesives, and other fastening means. In some embodiments, an adhesive, such as construction adhesive, can be used to adhere lightweight composite panels to a shaft liner frame and vertical studs, either in addition to or instead of screws or other mechanical fasteners. An adhesive can provides a more continuous bond interface between the lightweight composite panels and studs or shafter liner frame, thereby distributing the load more evenly and improving shear strength of the shaft liner structure. The use of adhesive attachment in addition to or instead of screws can eliminate discrete attachment points, creating a more solid and continuous bond that can better resist lateral forces and improve shear strength of the shaft liner structure.

### B. Lightweight Composite Panels With Polymer or Plaster Layer

In order for lightweight composite panels to function more effectively as show walls (e.g., similar to drywall), such as where it may be desired to apply an interior finish, such as paint, wallpaper, or molding (e.g., wainscot, wood paneling, or crown molding), the lightweight composite panel functions as a core composite panel structure that is modified by forming a polymer or plaster finish layer over at least one of the fiber mesh reinforced cementitious (or other protective) layers of the core composite panel structure. The polymer or plaster finish layer can be generally white in color, although other colors are possible if desired. Additional information relating to the manufacture and use of composite wall panels with a polymer finish that can be used to construct show walls is disclosed in U.S. application Ser. No. 19/343,601, filed Sep. 29, 2025, which is incorporated by reference. Additional information relating to the manufacture and use of composite wall panels with plaster finish that can be used to construct show walls is disclosed in U.S. patent application Ser. No. 19/306,817, filed Aug. 21, 2025, which is incorporated by reference.

Composite wall panels can include a light colored (e.g., white or off white) polymer or plaster finish layer formed over at least the exterior surface of the exterior fiber mesh reinforced cementitious (or other protective) layer, and optionally the side edges, giving the composite wall panels the appearance of wallboard without paper. Because composite wall panels can include fiber mesh reinforced cementitious (or other protective) layers, along with a waterproof interior polymer or inorganic foam core, they are both waterproof and substantially stronger than conventional gypsum drywall. Lightweight composite wall panels can be used, for example, in embodiments where it is desired to construct a vertical shaft liner that includes one or more show walls.

The composite wall panels include a lightweight foam core sandwiched between two fiber mesh reinforced cementitious (or other protective) layers, but with an additional polymer or plaster finish layer applied on at least one protective layer to yield wall panels that can substitute for gypsum drywall. The polymer or plaster finish layer can be textured, sanded, painted, wallpapered, and the like, similar to the surface of conventional gypsum board. However, the polymer or plaster finish layer can have a desired surface finish that eliminates the requirement to apply a finish to the paper surface of conventional gypsum drywall. The composite wall panels can be attached to a shaft liner frame or other structural elements using screws, nails, adhesives, or other known attachment means. The composite wall panels can also include bevels (e.g., 2 or 4) to permit placement of multiple adjacent composite wall panels, followed by application of drywall patch (taping and mudding) to hide the joints. Specialized connectors, such as washers with enlarged surfaces and penetrating prongs can be used to join adjacent composite wall panels together.

In some embodiments, the composite wall panels include a polymer finish layer that comprises a curable resin applied to one or both sides of the core composite panel structure and that is caused or allowed to cure. The curable resin coating layer can serve as the final surface layer for the composite wall panels. In some embodiments, the finish layer can be formed from a light-curable, UV-curable, and/or chemical-curable resin, examples of which include, but are not limited to, acrylic or methacrylic resins, aliphatic urethane acrylates, epoxy acrylates, polyester acrylates, and hybrids. An appropriate resin can be selected based on target hardness, flexibility, and adhesion properties. UV-curable resins include a photoinitiator to trigger polymerization upon UV exposure. Examples include, but are not limited to, benzoin ethers, acylphosphine oxides (e.g., diphenyl(2,4,6-trimethylbenzoyl) phosphine oxide, or TPO), and benzophenones depending on desired cure rate and depth. Alternatively, chemical cure resins known in the art can be used, such as the UV-curable resins mentioned above but which are modified to include a chemical initiator instead of, or in addition to, the photoinitiator. Examples of chemical initiators include peroxides (e.g., benzoyl peroxide), which are sometimes paired with an amine in a 2-part system, and cross-linkers.

In some embodiments, it may be desirable to apply and process the polymer finish layer in a manner that provides what is known in the industry as “level 5” finish, or “drywall finish level 5”. A level 5 finish is defined by the Gypsum Association, the trade association for drywall professionals, and is a premium finish that typically commands a much higher cost than lower level finishes. Providing a composite wall panel having a level 5 finish can eliminate the many steps and time required to prepare ordinary drywall to have a level 5 finish. This saves labor costs and time, including the time required for each coat of joint compound to dry and then be sanded.

In some embodiments, the composite wall panels include a plaster layer. A fresh plaster composition that can be used to form the plaster layer comprises mixture products of water, hydraulic cement, preferably white cement, calcium carbonate, aluminum oxide, silicon dioxide, cellulose ether, and latex. In a more particular embodiment, the fresh plaster composition used to form the plaster layer can be formed by mixing together the following components (expressed in weight percent) to form a fresh, flowable plaster composition, which is applied to one or both sides of the core composite panel structure, and then allowed to harden or cure:

| | |
|---|---|
| Hydraulic cement | 30-50% |
| Calcium carbonate | 40-70% |
| Aluminum oxide (Al₂O₃) | 1-3% |
| Silicon dioxide | 4-8% |
| Calcium oxide | 2-5% |
| Hydroxypropyl | 0.2-06% |
| methylcellulose | |
| Latex powder | 2-4% |
| Water | (0.5 to 1.5, or 0.75 to 1.25, or 1 part |
| | water per 2.5 parts of dry ingredients) |

The hydraulic cement typically includes Portland cement, preferably white cement for aesthetic reasons, but may also include supplementary cementitious materials (SCMs), such as ground granulated blast furnace slag (GGBFS), fly ash, natural pozzolan, silica fume, microsilica, metakaoline, ground glass, calcined clay, finely ground quartz, limestone powder, and the like. The Portland cement comprises ground cement clinker interground with gypsum for set control and limestone as a filler. For aesthetic reasons, SCMs, when included, are preferably white or light colored. The silicon dioxide can be 150 mesh ground quartz sand. The latex powder can be redispersible 558 latex, which can be an ethylene/vinyl acetate copolymer, vinyl acetate/versatate copolymer, acrylic copolymer, etc. The latex powder can improve adhesion of the plaster layer to a cementitious layer. The cementitious composition may include other components, such as natural hydraulic lime, calcium silicate, and/or expanded glass, which can increase fire and heat resistance.

The dry components of the plaster composition, known euphemistically as “putty powder”, can be dry mixed in a mixer to form an evenly mixed dry blend. Then the water is added to the mixture to form a fresh flowable plaster composition that can be sprayed. A spray gun is used to apply the fresh plaster composition to the fiber mesh reinforced cementitious layer of a basic lightweight composite panel (e.g., with or without beveled edges). The amount of plaster composition applied should be sufficient to cover the fiber mesh reinforced cementitious layer so that the grid-like texture is no longer visible, forming a smooth surface (or surface having a desired texture). The plaster composition is then allowed to cure for 7 days to form a hardened surface, which can be polished if desired to yield a smooth surface.

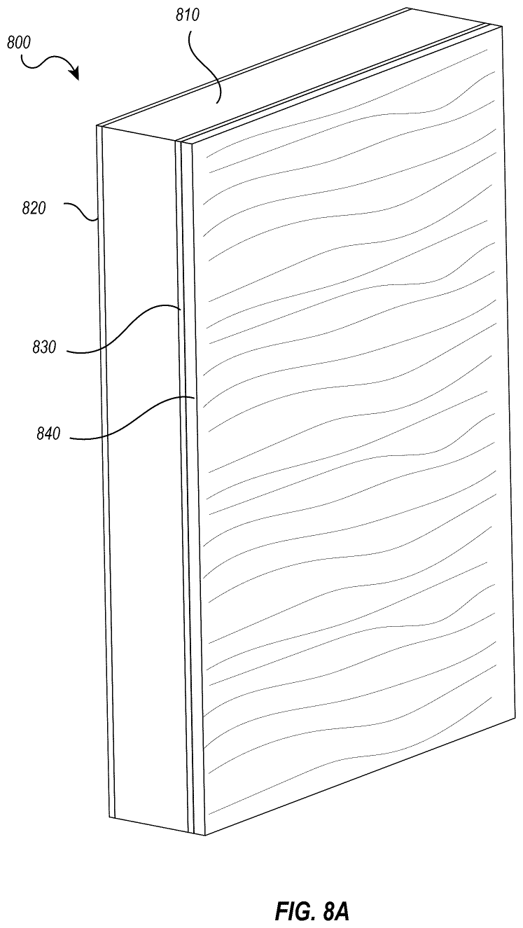

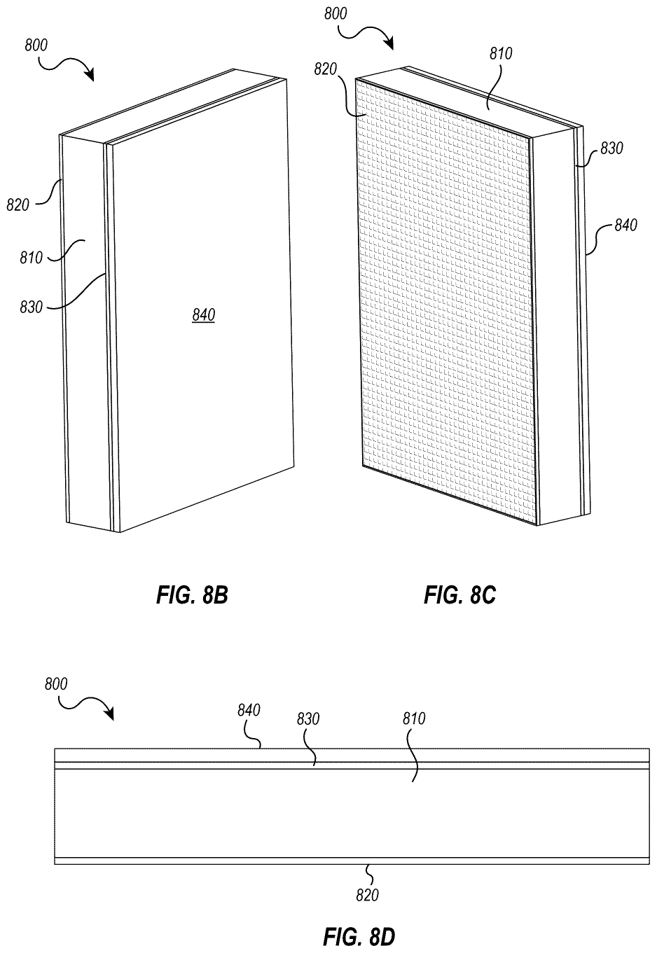

Reference is made to FIGS. 8A-12B, which illustrate example embodiments of composite wall panels with a polymer or plaster finish, which can be used to make show walls of a shaft liner. FIG. 8A illustrates the layered structure of an example composite wall panel 800. The composite wall panel 800 comprises a core composite panel structure, including a foam core 810 sandwiched between a first fiber mesh reinforced cementitious (or other protective) layer 820 and a second fiber mesh reinforced cementitious (or other protective) layer 830. A finish layer 840 is formed over the second fiber mesh reinforced cementitious (or other protective) layer 830, which forms the show side, i.e., that will be visible as the interior wall surface before applying a desired finish, such as paint and/or wallpaper. The finish layer 840 in this embodiment is shown as having a textured surface that provides the look of rough plaster.

The fiber mesh reinforced cementitious layers 820, 830 provide several advantages. The textured surface of the second fiber mesh reinforced cementitious layer 830 can enhance the bond strength of the finish layer 840 and prevent delamination. Because the first fiber mesh reinforced cementitious layer 820 does not include a finish layer it can have a textured surface that facilitates adhesion of the composite wall panel 800 to a shaft liner frame, auxiliary vertical wall, studs, or other underlying structure using an adhesive or glue. In addition, the first and second fiber mesh reinforced cementitious (or other protective) layers 820, 830 provide high strength, which permits the composite wall panel 800 to support relatively heavy loads, such as pictures, television sets, or other appliances using nails or screws, particularly if they can penetrate through both the first and second fiber mesh reinforced cementitious (or other protective) layers 820, 830.

FIGS. 8B-8D illustrate another embodiment of a composite wall panel 800 made from a core composite panel structure with a smooth polymer or plaster finish layer formed over the exposed or show side. The composite wall panel 800 comprises the core composite panel structure, including a foam (e.g., polymer) core 810 sandwiched between first and second fiber mesh reinforced cementitious (or other protective) layers 820, 830. A finish layer 840 is formed over the second fiber mesh reinforced cementitious (or other protective) layer 830, which forms the show side that will be visible as the interior wall surface before applying a desired final finish, such as paint or wallpaper. The finish layer 840 in this embodiment has a smooth surface finish. It will be appreciated that the finish layer 840 can have any desired surface finish, including smooth to very smooth, including having a level 5 finish, which is a substantial improvement over traditional gypsum drywall panels.

The textured surface of the second fiber mesh reinforced cementitious (or other protective) layer 830 can enhance the bond strength of the finish layer 840, which prevents delamination. The first fiber mesh reinforced cementitious (or other protective) layer 820 can have a textured surface that facilitates adhesion of the composite wall panel 800 to shaft liner frames, studs, auxiliary vertical walls, or other underlying structure. The first and second fiber mesh reinforced cementitious (or other protective) layers 820, 830 provide high strength, which permits the composite wall panel 800 to support relatively heavy loads, such as pictures, television sets, or other appliances using nails or screws, particularly if they can penetrate through both the first and second fiber mesh reinforced cementitious (or other protective) layers 820, 830.

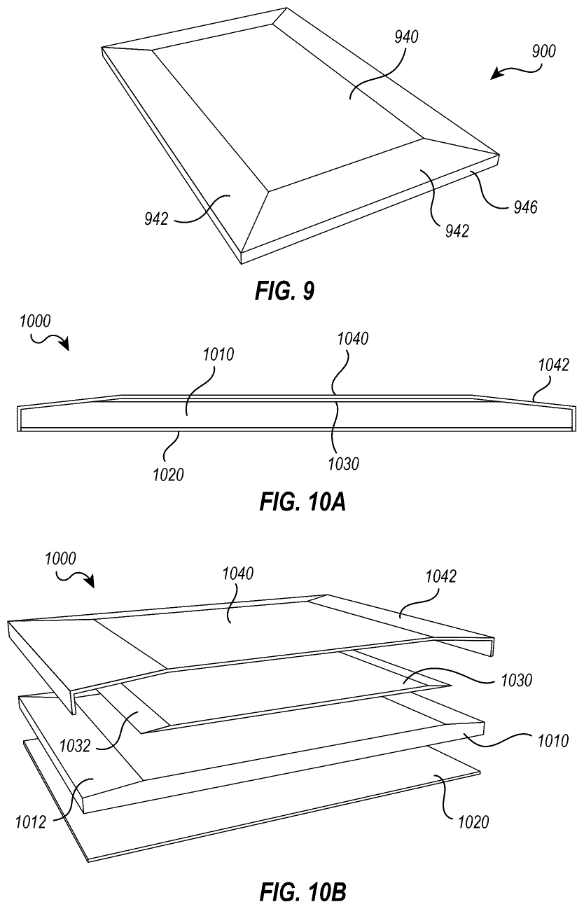

FIGS. 9-11B illustrate composite wall panels 900, 1000, 1100 having beveled edges. FIG. 9 schematically illustrates a composite wall panel 900 having four beveled edges 942, one in each of the four sides, and a finish layer 940 covering the entire upper surface, beveled edges 942, and side ends 946. The finish layer 940 over the beveled edges 942 can be applied over beveled portions of a fiber mesh reinforced cementitious layer (not shown) that extend over the foam core (not shown) in the region of the beveled edges 942 to provide the beveled edges 942 with a smooth finish and additional strength.

FIG. 10A is a side cross-sectional view, and FIG. 10B is an exploded view, showing the layered structure of an embodiment of a composite wall panel 1000. As illustrated in FIG. 10A, the composite wall panel 1000 includes a foam (e.g., polymer or inorganic) core 1010, a first fiber mesh reinforced cementitious (or other protective) layer 1020 on an interior side, a second fiber mesh reinforced cementitious (or other protective) layer 1030 on an exterior side, and a finish layer 1040 formed over the second fiber mesh reinforced cementitious (or other protective) layer 1030. The composite wall panel 1000 includes beveled edges 1042, with a beveled portion 1012 of the foam core 1010 being partially covered by a believed portion 1032 of the second fiber mesh reinforced cementitious (or other protective) layer 1030, which in turn is covered by a beveled portion of the finish layer 1040. In this way, the beveled edges 1042 can have similar strength as the non-beveled portion of the composite wall panel 1000, which permits using nails, screws, or other fastening means to fasten the composite wall panel 1000 to shafter liners, studs, auxiliary vertical walls, or other structural elements through the beveled edges 1042.

FIG. 10B is an exploded view of the composite wall panel 1000 that more particularly illustrates the layered structure. The composite wall panel 1000 includes a foam core 1010, a first fiber mesh reinforced cementitious (or other protective) layer 1020, which can include a first cementitious layer with embedded first fiberglass mesh (not shown), a second fiber mesh reinforced cementitious (or other protective) layer 1030, which can include a second cementitious layer with embedded second fiberglass mesh (not shown), and a finish layer 1040 formed over the second fiber mesh reinforced cementitious (or other protective) layer 1030. The composite wall panel 1000 also includes beveled edges 1042, which includes a beveled portion 1012 of the foam core 1010 partially covered by a beveled portion 1032 of the second fiber mesh reinforced cementitious (or other protective) layer 1030, which are both covered by the beveled portion 1042 of the finish layer 1040.

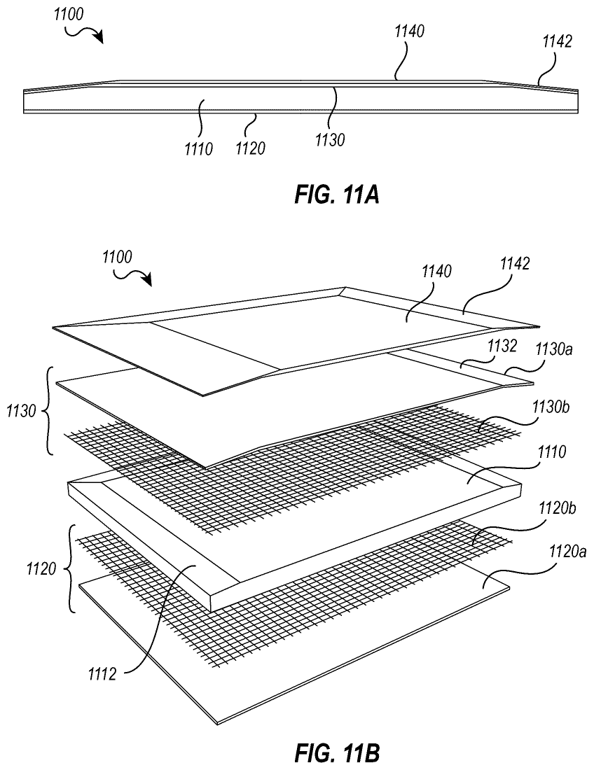

FIG. 11A is a side cross-sectional view, and FIG. 11B is an exploded view, showing the layered structure of another embodiment of a composite wall panel 1100. As illustrated in FIG. 11A, the composite wall panel 1100 includes a foam (e.g., polymer or inorganic) core 1110, a first fiber mesh reinforced cementitious (or other protective) layer 1120 on an interior side, a second fiber mesh reinforced cementitious (or other protective) layer 1130 on an exterior side, and a finish layer 1140 formed over the second fiber mesh reinforced cementitious (or other protective) layer 1130. The composite wall panel 1100 includes beveled edges 1142, with a beveled portion 1112 of the foam core 1110 being entirely covered by a beveled portion 1132 of the second fiber mesh reinforced cementitious (or other protective) layer 1130, which in turn is covered by a beveled portion 1142 of the finish layer 1140. In this way, the beveled edges 1142 can have the same reinforcement and strength as the non-beveled portion of the composite wall panel 1100, which permits using nails, screws, or other fastening means to fasten the composite wall panel 1100 to a shaft liner frame, studs, auxiliary vertical walls, or other structural elements through the beveled edges 1142.

FIG. 11B is an exploded view of the composite wall panel 1100 that more particularly illustrates the layered structure. The composite wall panel 1100 includes a foam core 1110, a first fiber mesh reinforced cementitious layer 1120, which includes a first cementitious layer 1120a with embedded first fiberglass mesh 1120b, a second fiber mesh reinforced cementitious layer 1130, which includes a second cementitious layer 1130a with embedded second fiberglass mesh 1130b, and a finish layer 1140 formed over the second fiber mesh reinforced cementitious layer 1130. The composite wall panel 1100 also includes beveled edges 1142, which includes a beveled portion of the foam core 1110 entirely covered by a beveled portion of the second fiber mesh reinforced cementitious layer 1130, which is entirely covered by a beveled portion of the finish layer 1140.

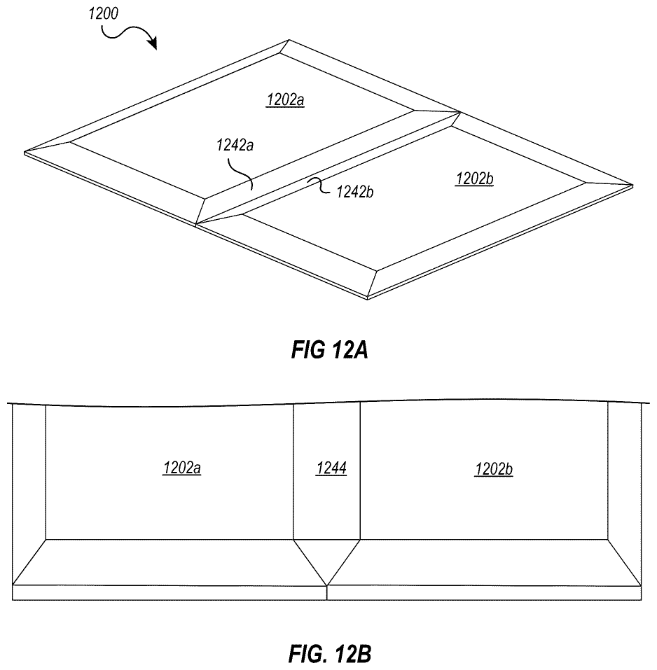

FIG. 12A illustrates two composite wall panels 1200 positioned side-by-side and abutting each other, each having a finish layer 1202a, 1202b and beveled edges 1242a, 1242b that are aligned to facilitate application of tape and drywall patch to hide the seam and join the composite wall panels 1200 together, as illustrated in FIG. 12B. FIG. 12A shows the beveled edges 1242a, 1242b covered by a portion of the finish layers 1202a, 1202b.

FIG. 12B illustrates two composite wall panels 1200 positioned side-by-side and abutting each other, with beveled edges 1234 aligned so as to permit the application of tape and drywall patch to join them together. FIG. 12B shows the beveled edges 1234 filled in with wall filler 1244 (e.g., drywall patch) such that the two composite wall panels 1200 have been joined together to yield a finished, seamless surface finish 1232. A level 5 finish can be achieved in a minimal number of steps by taping and plastering only the beveled edges 1242a, 1242b, followed by sanding the joint. Skim coating and sanding of the non-beveled portions of the finish layers 1202a, 1202b is not required if they already have a factory applied level 5 finish.

### C. Laminated Composite Wall Panels

Another version of lightweight composite panel that can be used to form a show wall of a shaft liner includes a fiber-based sheet laminated over one or both sides of the core composite panel structure to yield a laminated composite wall panel. An intermediate polymer layer can optionally be formed over one or both sides of the core composite panel structure to form a smooth surface to which the fiber-based sheet layer can be applied. In some embodiments, the intermediate polymer layer can be the same polymer materials used above to form composite wall panels with polymer finish layer. The fiber-based sheet layer can be generally white or off white in color, although other colors are possible if desired. Additional information relating to the manufacture and use of laminated composite wall panels is disclosed in U.S. patent application Ser. No. 19/343,312, filed Sep. 29, 2025, which is incorporated by reference.

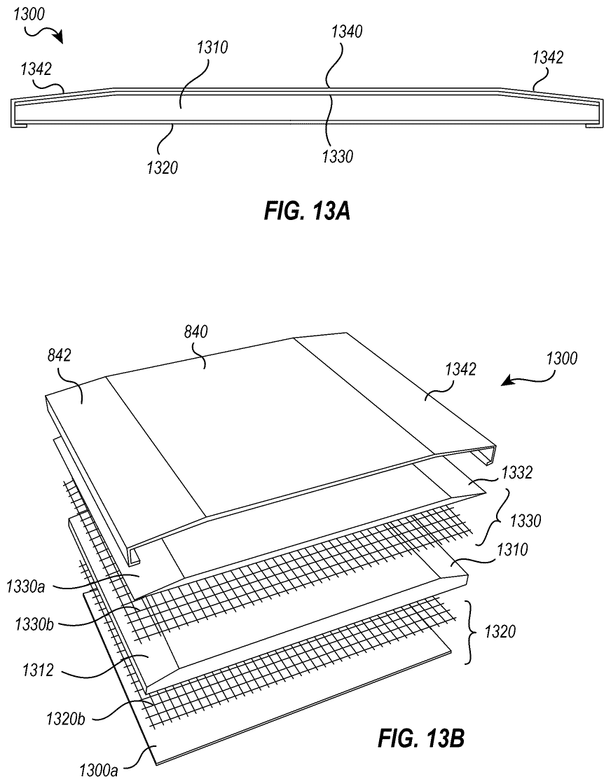

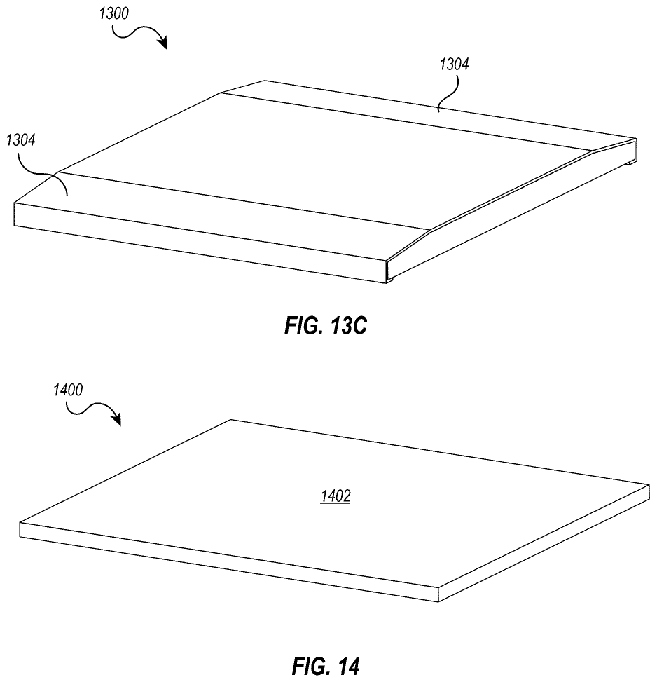

FIG. 13A is a side cross-sectional view, and FIG. 13B is an exploded view, showing the layered structure of an embodiment of a laminated composite wall panel 1300. As illustrated in FIG. 13A, the laminated composite wall panel 800 includes a foam (e.g., polymer) core 1310, a first fiber mesh reinforced cementitious (or other protective) layer 1320 on an interior side, a second fiber mesh reinforced cementitious (or other protective) layer 1330 on an exterior side, and a fiber-based sheet layer and optional intermediate polymer layer 1340 formed over the second fiber mesh reinforced cementitious (or other protective) layer 1330 and covering the sides and an outer perimeter portion of the first fiber mesh reinforced cementitious (or other protective) layer 1320. The laminated composite wall panel 1300 includes beveled edges 1342, with a beveled portion 1312 of the foam core 1310 being entirely covered by a beveled portion 1332 of the second fiber mesh reinforced cementitious (or other protective) layer 1330, which in turn is covered by a beveled portion 1342 of the fiber-based sheet layer and optional intermediate polymer layer 1340. In this way, the beveled edges 1342 can have the same reinforcement and strength as the non-beveled portion of the laminated composite wall panel 1300, which permits using nails, screws, or other fastening means to fasten the laminated composite wall panel 1300 to shaft liner frames, studs, auxiliary vertical walls, or other structural elements through the beveled edges 1342.

FIG. 13B is an exploded view of the laminated composite wall panel 1300 that more particularly illustrates the layered structure. The laminated composite wall panel 1300 includes a foam core 1310, a first fiber mesh reinforced cementitious layer 1320, which includes a first cementitious layer 1320a with embedded first fiberglass mesh 1320b, a second fiber mesh reinforced cementitious layer 1330, which includes a second cementitious layer 1330a with embedded second fiberglass mesh 1330b, and a fiber-based sheet layer and optional intermediate polymer layer 1340 formed over the second fiber mesh reinforced cementitious layer 1330 and covering the sides and an outer perimeter portion of the first fiber mesh reinforced cementitious (or other protective) layer 1320. The laminated composite wall panel 1300 also includes beveled edges 1342, which includes a beveled portion of the foam core 1310 entirely covered by a beveled portion 1332 of the second fiber mesh reinforced cementitious layer 1330, which is entirely covered by a beveled portion 1342 of the fiber-based sheet layer and optional intermediate polymer layer 1340.

FIG. 13C illustrates another example embodiment of a laminated composite wall panel 1300 with a fiber-based sheet layer 1302 and two beveled edges 1304. FIG. 13D illustrates an example laminated composite wall panel 1320 with a fiber-based sheet layer 1322 but no beveled edges.

FIGS. 12A-12B, discussed above relative to composite wall panels having a polymer or plaster finish, is also helpful in illustrating how laminated composite wall panels with beveled edges can be joined together. FIG. 12A illustrates two laminated composite wall panels 1200 positioned side-by-side and abutting each other, each having a fiber-based sheet layer 1202a, 1202b and beveled edges 1242a, 1242b that are aligned to facilitate application of tape and drywall patch to hide the seam and join the laminated composite wall panels 1200 together, as illustrated in FIG. 12B. FIG. 12A shows the beveled edges 1242a, 1242b covered by a portion of the fiber-based sheet layers 1202a, 1202b.

FIG. 12B illustrates two laminated composite wall panels 1200 positioned side-by-side and abutting each other, with beveled edges 1234 aligned so as to permit the application of tape and drywall patch to join them together. FIG. 12B shows the beveled edges 1234 filled in with wall filler 1244 (e.g., drywall patch) such that the two laminated composite wall panels 1200 have been joined together to yield a finished, seamless surface finish.

### D. Specialized Fasteners for Lightweight Composite Panels

In some embodiments, screws, rivets, or other fasteners used to attach lightweight composite panels to a shaft liner frame, auxiliary vertical walls, or other structural elements include corresponding washers or enlarged heads that are at least about 20 mm, 25 mm, 30 mm, 35 mm, 40 mm, 45 mm, 50 mm, 55 mm, 60 mm, 65 mm, 70 mm, 75 mm, or 80 mm, in diameter. This ensures sufficiently large surface contact between the screws or other fasteners and the fiber mesh reinforced cementitious (or other protective) layer so that the screws or other fasteners have a much lower tendency to tear through the lightweight composite panels or otherwise compromise the structural integrity of the wall structure formed by the lightweight composite panels.

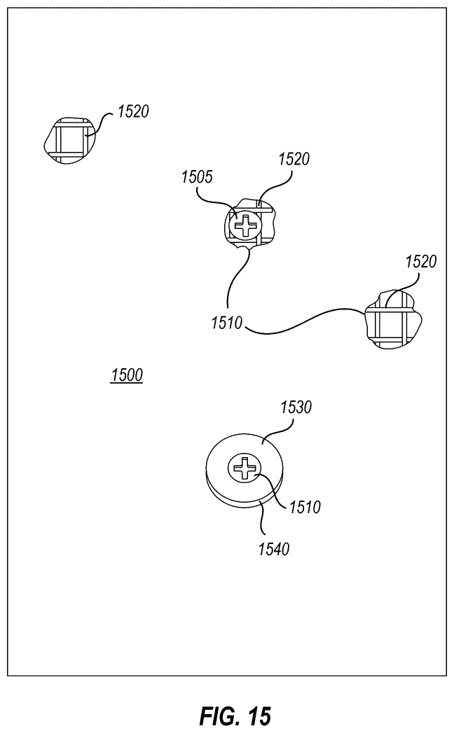

To illustrate this point, FIG. 15 is a diagram that illustrates a lightweight composite panel 1500 with holes formed by the heads 1505 of screws 1510 passing all the way through the exterior fiber mesh reinforced cementitious layer. Remnants of fiber mesh 1520 of the damaged fiber mesh reinforced cementitious layer can be seen. The holes were the result of screw heads 1505 being too small (i.e., having too little surface area) to prevent the screw heads 1505 from perforating and penetrating all the way through the exterior fiber mesh reinforced cementitious layer. FIG. 15 further illustrates a screw 1510 with a washer 1530 abutting the surface of the lightweight composite panel 1500 without having passed through the exterior fiber mesh reinforced cementitious layer. Some cracking 1540 of the fiber mesh reinforced cementitious layer may occur, indicating that the washer 1530 may reduce, but not completely prevent, damage to the fiber mesh reinforced cementitious layer.

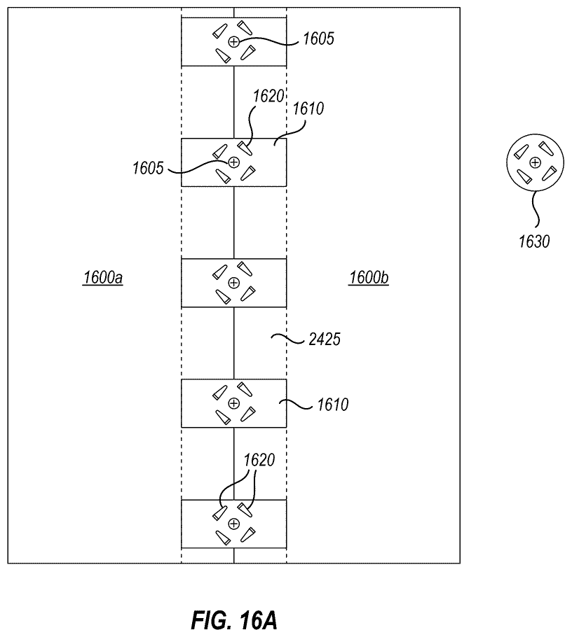

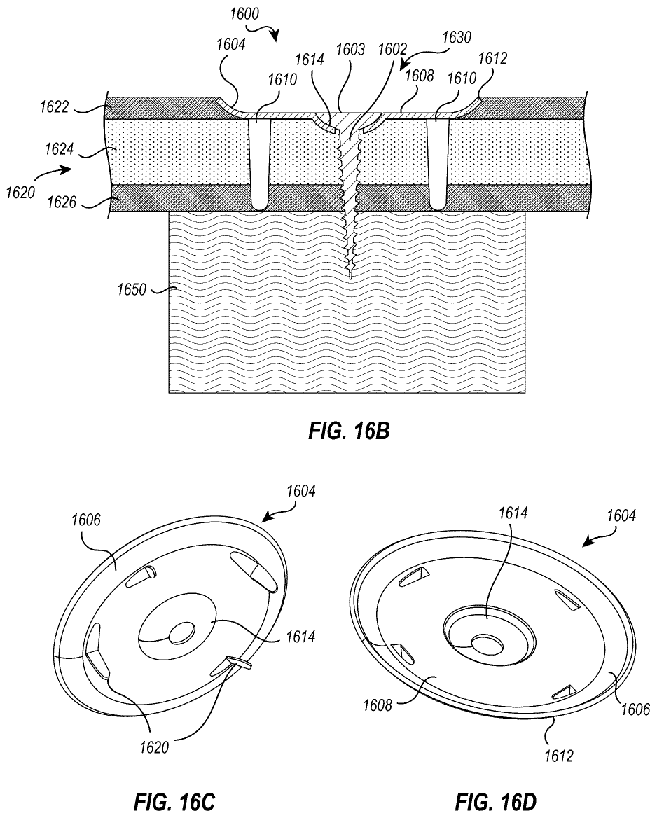

Reference is now made to FIGS. 16A-16D, which illustrate the use of specialized washers with enlarged surface areas and penetrating prongs that help fix the washers in place relative to the lightweight composite panels, prevent rotation when screws are being driven into studs or other structural elements of a shaft liner frame, and add additional lateral strength between the washers and the lightweight composite panels. The penetrating prongs can also be designed to abut the underlying shaft liner frame, stud, or other structural element and act as a stop to prevent the washers from being driven too far into the lightweight composite panel and undesirably crushing or fracturing the exterior fiber mesh reinforced cementitious layer.

FIG. 16A more particularly illustrates the use of screws 1605 and specialized washers 1610 having a plurality of penetrating prongs 1620. The specialized washers 1610 are rectangular in shape in order to overlap the end surfaces of adjacent lightweight composite panels 1600a, 1600b. The penetrating prongs 1620 penetrate through and become embedded within the lightweight composite panels 1000a, 1000b, including though the exterior fiber mesh reinforced layers and at least partially through the foam cores of the lightweight composite panels 1600a, 1600b. The penetrating prongs 1620 hold the specialized washers 1610 in a desired position relative to the lightweight composite panels 1600a, 1600b and prevent rotation while the screws 1605 are being driven through the lightweight composite panels 1600a, 1600b and into an underlying stud 1625 or other structural elements of a shaft liner frame. The penetrating prongs 1620 thereby ensure that left and right wings of the specialized washers 1610 reliably overlap corresponding surfaces of the left and right lightweight composite panels 1600a, 1600b to tie them together. The penetrating prongs 1620 can also provide a load spreading/pressure spreading effect, i.e., the prongs 1620 distribute the normal and lateral pressure from the screw 1605 to the prongs 1620. The specialized washers 1610 and penetrating prongs 1620 provide greater lateral tension of the screw and washer ensemble relative to the lightweight composite panels 1600a, 1600b, thereby increasing the overall strength of the vertical shaft liner. FIG. 16A also illustrates an embodiment of another specialized washer 1630 that has a circular shape.

FIGS. 16B-16D illustrate a fastener assembly 1600 comprising a screw 1602 and specialized washer 1604 with a circular shape, concave interior portion 1608, enlarged surface area, and penetrating prongs 1610 for attaching a lightweight composite panel 1620 to a stud 1650 or other structural element of a shaft liner frame. The penetrating prongs 1610 help fix the washer 1604 in place relative to the lightweight composite panel 1620 and prevent rotation of the washer 1604 when the screw 1602 is driven into the stud 1650 or other structural element of a shaft liner frame and add additional lateral strength between the washers 1604 and the lightweight composite panel 1620. The penetrating prongs 1610 can also be designed to abut the underlying stud 1650 or other structural element and act as a stop to prevent the washer 1604 from being driven too far into the lightweight composite panel 1620 and undesirably crushing or fracturing the exterior fiber mesh reinforced cementitious (or other protective) layer 1622, which could reduce the strength of the panel.

FIG. 16B more particularly illustrates the use of a specialized fastener assembly 1600 comprising a screw 1602 and specialized washer 1604. Although the specialized washer 1604 in this embodiment is illustrated as having a circular washer body 1606, other embodiments of specialized washers may include enlarged rectangular-shaped washer bodies (not shown) designed to more completely overlap and adjoin adjacent lightweight composite panels. The penetrating prongs 1610 are designed to penetrate through and become embedded within a lightweight composite panel 1620, including though the exterior fiber mesh reinforced cementitious (or other protective) layer 1622, at least partially through the foam core 1624, and optionally through the interior fiber mesh reinforced cementitious (or other protective) layer 1626 to make abutment with a stud 1650 or other structural element of a shaft liner frame. The penetrating prongs 1610 help retain the specialized washer 1604 in a desired position relative to the lightweight composite panel 1620 and prevent rotation while the screw 1602 is driven through the lightweight composite panel 1620 and into the underlying stud 1650 or other structural element of a shaft liner frame. The penetrating prongs 1610 can provide a load spreading/pressure spreading effect to distribute normal and lateral pressure from the screw 1602 and washer body 1606 to the prongs 1610. The specialized washer 1604 and penetrating prongs 1610 provide greater lateral tension of the screw and washer assembly 1600 relative to the lightweight composite panel 1620, thereby increasing the strength of the wall structure.

FIG. 16C is a bottom perspective view and FIG. 16D is a top perspective view that more particularly illustrate features of the specialized washer 1604. The washer body 1606 can have an enlarged diameter in order to provide higher surface area and increase contact between the specialized washer 1604 and an adjacent fiber reinforced cementitious (or other protective) layer of a lightweight composite panel 1620. The washer body 1606 can have a concave interior portion 1608, which permits an outer rim 1612 to become substantially flush with, and the concave interior portion 1608 to advance below, the adjacent fiber reinforced cementitious (or other protective) layer when used to attach a lightweight composite panel 1620 to a stud, as shown in FIG. 16B. This allows the concave interior portion 1608 to partially compress the interior foam core 1624 and exterior fiber reinforced cementitious (or other protective) layer 1622 of the lightweight composite panel 1620 to provide firm and reliable attachment of the panel 1620 to the shaft liner frame. The washer body 1606 can include a countersink 1614 that accommodates the head 1603 of the screw 1602 so that the screw head 1603 does not protrude beyond the surface of the washer body 1606 when driven into a stud 1650 or other structural element of a shaft liner frame.

In some embodiments, an appropriate seam coat can be applied over at least a portion of an exterior show wall, including over any exposed screws, washers, or other mechanical fasteners used to attach the lightweight composite panels to the shaft liner frame, and over any joints or seams, fiber mesh tape, polyurethane, or other exposed sealants on or in the exterior wall structure.

### Additional Terms & Definitions

While certain embodiments of the present disclosure have been described in detail, with reference to specific configurations, parameters, components, elements, etcetera, the descriptions are illustrative and are not to be construed as limiting the scope of the claimed invention.

Furthermore, it should be understood that for any given element of component of a described embodiment, any of the possible alternatives listed for that element or component may generally be used individually or in combination with one another, unless implicitly or explicitly stated otherwise.

In addition, unless otherwise indicated, numbers expressing quantities, constituents, distances, or other measurements used in the specification and claims are to be understood as optionally being modified by the term “about” or its synonyms. When the terms “about,” “approximately,” “substantially,” or the like are used in conjunction with a stated amount, value, or condition, it may be taken to mean an amount, value or condition that deviates by less than 20%, less than 10%, less than 5%, less than 1%, less than 0.1%, or less than 0.01% of the stated amount, value, or condition. At the very least, and not as an attempt to limit the application of the doctrine of equivalents to the scope of the claims, each numerical parameter should be construed in light of the number of reported significant digits and by applying ordinary rounding techniques.

Any headings and subheadings used herein are for organizational purposes only and are not meant to be used to limit the scope of the description or the claims.

It will also be noted that, as used in this specification and the appended claims, the singular forms “a,” “an” and “the” do not exclude plural referents unless the context clearly dictates otherwise. Thus, for example, an embodiment referencing a singular referent (e.g., “widget”) may also include two or more such referents.

It will also be appreciated that embodiments described herein may also include properties and/or features (e.g., ingredients, components, members, elements, parts, and/or portions) described in one or more separate embodiments and are not necessarily limited strictly to the features expressly described for that particular embodiment. Accordingly, the various features of a given embodiment can be combined with and/or incorporated into other embodiments of the present disclosure. Thus, disclosure of certain features relative to a specific embodiment of the present disclosure should not be construed as limiting application or inclusion of said features to the specific embodiment. Rather, it will be appreciated that other embodiments can also include such features.

1. A method of constructing a heat and moisture resistant shaft liner at least partially enclosing a vertical shaft, comprising:
forming or providing a three-dimensional shaft liner frame around at least a portion of a perimeter of the vertical shaft, the shaft liner frame comprising upper tracks or runners with down-facing flanges and channels and corresponding lower tracks or runners with up-facing flanges and channels;
positioning main lightweight composite panels within the shaft liner frame to form main vertical shaft walls extending between the upper and lower tracks or runners, each main vertical shaft wall comprising adjacent vertical shaft wall columns, and each main vertical shaft wall being angled relative to adjacent main vertical shaft walls so that the main vertical shaft walls at least partially enclose the vertical shaft;
positioning vertical studs having side-facing flanges and channels within the shaft liner frame to interconnect adjacent vertical shaft wall columns lying in the same plane, each vertical stud being placed next to an installed vertical shaft wall column prior to installing another vertical shaft wall column adjacent to the installed vertical shaft wall column in the same plane; and
fastening a plurality of auxiliary panels to the shaft liner frame to form one or more auxiliary vertical walls, the auxiliary panels comprising additional lightweight composite panels and/or gypsum boards, each auxiliary vertical wall being angled relative to one or more adjacent auxiliary vertical walls to at least partially enclose or hide the shaft liner frame,
the main lightweight composite panels and additional lightweight composite panels, when included, each comprising:
a foam core having a first surface and a second surface opposite the first surface;
a first protective layer selected from a first fiber reinforced cementitious layer, thermoset polymer layer, or magnesium oxide layer formed over and covering at least a portion of the first surface of the foam core; and
a second protective layer selected from a second fiber reinforced cementitious layer, thermoset polymer layer, or magnesium oxide layer formed over and covering at least a portion of the second surface of the foam core.

2. The method of claim 1, the three-dimensional shaft liner frame further comprising first and second vertical tracks or runners with side-facing flanges and channels positioned adjacent to first and second vertical side ends, respectively, of each main vertical shaft wall.

3. The method of claim 1, wherein the shaft liner comprises four main vertical shaft walls positioned at angles relative to each other so as to at least partially enclose a corresponding vertical section of the vertical shaft.

4. The method of claim 1, wherein the vertical shaft has a rectangular cross section and each main vertical shaft wall is positioned at a right angle relative to each adjacent main vertical shaft wall.

5. The method of claim 1, wherein the shaft liner comprises multiple vertically stacked three-dimensional shaft liner frames and multiple vertically stacked main vertical shaft walls positioned so as to at least partially enclose the vertical shaft along its entire height.

6. The method of claim 1, wherein the vertical shaft is an elevator shaft, wherein the shaft liner comprises first auxiliary vertical walls fastened to sides of the shaft liner frame facing away from the elevator shaft and at least one second auxiliary vertical wall fastened to the shaft liner frame over one or more of the first auxiliary vertical walls to function as an exterior show wall outside the elevator shaft.

7. The method of claim 1, wherein the vertical shaft is a stairwell shaft, wherein the shaft liner comprises first auxiliary vertical walls fastened to sides of the shaft liner frame facing into the stairwell shaft to function as interior show walls inside the stairwell shaft and second auxiliary vertical walls fastened to sides of the shaft liner frame facing away from the stairwell shaft.

8. The method of claim 1, wherein the vertical shaft is a mechanical chase or an air shaft.

9. The method of claim 1, wherein the tracks or runners comprise metal (e.g., steel) J-tracks or J-runners having a center wall and two spaced apart sidewalls extending laterally from the center wall, and wherein a first sidewall is longer than a second sidewall.

10. The method of claim 1, wherein the vertical studs are metal (e.g., steel) and selected from C-T studs, C-H studs, or I-studs.

11. The method of claim 1, wherein the main lightweight composite panels have a cross-sectional thickness of about ¾ inch to about 1½ inch, or about ⅞ inch to about 1¼ inch, or about 1 inch.

12. The method of claim 1, wherein at least some of the auxiliary panels comprise lightweight composite panels having a cross-sectional thickness of about ⅜ inch to about ⅝ inch, or about 7/16 inch to about 9/16 inch, or about ½ inch.

13. The method of claim 1, wherein at least some of the auxiliary panels comprise gypsum boards having a cross-sectional thickness of about ⅜ inch to about ⅝ inch, or about 7/16 inch to about 9/16 inch, or about ½ inch.

14. The method of claim 1, wherein the auxiliary panels form exterior and/or interior show walls and comprise lightweight composite panels having a polymer finish, plaster finish, or paper layer on a surface of at least one of the first or second protective layers.

15. The method of claim 1, wherein the three-dimensional shaft liner frame includes an essentially rectangular opening, such as for an elevator door or stairwell door, framed by spaced apart upper and lower tracks or runners, and spaced apart first and second vertical tracks or runners, wherein the essentially rectangular opening omits lightweight composite panels.

16. A heat and moisture resistant shaft liner at least partially enclosing a vertical shaft, comprising:
a three-dimensional shaft liner frame formed around at least a portion of a perimeter of the vertical shaft, the shaft liner frame comprising upper tracks or runners with down-facing flanges and channels and corresponding lower tracks or runners with up-facing flanges and channels;
main lightweight composite panels positioned within the shaft liner frame and forming main vertical shaft walls extending between the upper and lower tracks or runners, each main vertical shaft wall comprising adjacent vertical shaft wall columns, and each main vertical shaft wall being angled relative to adjacent main vertical shaft walls so that the main vertical shaft walls at least partially enclose the vertical shaft;
vertical studs having side-facing flanges and channels positioned in the shaft liner frame and interconnecting adjacent vertical shaft wall columns in the same plane; and
a plurality of auxiliary panels fastened to the shaft liner frame and forming one or more auxiliary vertical walls, the auxiliary panels comprising additional lightweight composite panels and/or gypsum boards, each auxiliary vertical wall being angled relative to one or more adjacent auxiliary vertical walls to at least partially enclose or hide the shaft liner frame,
the main lightweight composite panels and additional lightweight composite panels, when included, each comprising:
a foam core having a first surface and a second surface opposite the first surface;
a first protective layer selected from a first fiber reinforced cementitious layer, thermoset polymer layer, or magnesium oxide layer formed over and covering at least a portion of the first surface of the foam core; and
a second protective layer selected from a second fiber reinforced cementitious layer, thermoset polymer layer, or magnesium oxide layer formed over and covering at least a portion of the second surface of the foam core.

17. A heat and moisture resistant shaft liner at least partially enclosing an elevator shaft, comprising:
a three-dimensional shaft liner frame formed around at least a portion of a perimeter of the elevator shaft, the shaft liner frame comprising upper tracks or runners with down-facing flanges and channels and corresponding lower tracks or runners with up-facing flanges and channels;
main lightweight composite panels positioned within the shaft liner frame and forming main elevator shaft walls extending between the upper tracks or runners and corresponding lower tracks or runners, with an upper end of each main elevator shaft wall positioned in a down-facing channel and a lower end of the main elevator shaft wall positioned in a corresponding up-facing channel, each main elevator shaft wall comprising a plurality of adjacent elevator shaft wall columns lying in the same plane, and each main elevator shaft wall being oriented at an angle relative to one or more adjacent main elevator shaft walls so that the main elevator shaft walls at least partially enclose the elevator shaft;
vertical studs having side-facing flanges and channels positioned in the shaft liner frame and interconnecting adjacent elevator shaft wall columns lying in the same plane;
first auxiliary panels comprising additional lightweight composite panels and/or gypsum boards fastened to sides of the shaft liner frame facing away from the elevator shaft and forming first auxiliary vertical walls, each first auxiliary vertical wall being angled relative to one or more adjacent first auxiliary vertical walls to at least partially enclose or hide the shaft liner frame; and
second auxiliary panels comprising additional lightweight composite panels and/or gypsum boards fastened to the shaft liner frame over one or more of the first auxiliary vertical walls to function as an exterior show wall outside the elevator shaft,
the main lightweight composite panels and additional lightweight composite panels, when included, each comprising:
a foam core having a first surface and a second surface opposite the first surface;
a first protective layer selected from a first fiber reinforced cementitious layer, thermoset polymer layer, or magnesium oxide layer formed over and covering at least a portion of the first surface of the foam core; and
a second protective layer selected from a second fiber reinforced cementitious layer, thermoset polymer layer, or magnesium oxide layer formed over and covering at least a portion of the second surface of the foam core.

18. The shaft liner of claim 17, wherein the main lightweight composite panels have a cross-sectional thickness in a range of about ¾ inch to about 1½ inch, or about ⅞ inch to about 1¼ inch, or about 1 inch, and wherein the second and third auxiliary panels have a cross-sectional thickness in a range of about ⅜ inch to about ⅝ inch, or about 7/16 inch to about 9/16 inch, or about ½ inch.

19. A heat and moisture resistant shaft liner at least partially enclosing a stairwell shaft, comprising:
a three-dimensional shaft liner frame formed around at least a portion of a perimeter of the stairwell shaft, the shaft liner frame comprising upper tracks or runners with down-facing flanges and channels and corresponding lower tracks or runners with up-facing flanges and channels;
main lightweight composite panels positioned within the shaft liner frame and forming main stairwell shaft walls extending between the upper tracks or runners and corresponding lower tracks or runners, with an upper end of each main stairwell shaft wall positioned in a down-facing channel and a lower end of the main stairwell shaft wall positioned in a corresponding up-facing channel, each main stairwell shaft wall comprising a plurality of adjacent stairwell shaft wall columns lying in the same plane, and each main stairwell shaft wall being oriented at an angle relative to one or more adjacent main stairwell shaft walls so that the main stairwell shaft walls at least partially enclose the stairwell shaft;
vertical studs having side-facing flanges and channels positioned in the shaft liner frame and interconnecting adjacent stairwell shaft wall columns lying in the same plane;
first auxiliary panels comprising additional lightweight composite panels and/or gypsum boards fastened to sides of the shaft liner frame facing into the stairwell shaft to function as interior show walls inside the stairwell shaft, each interior show wall being angled relative to one or more adjacent interior show walls to at least partially enclose or hide the shaft liner frame; and
second auxiliary panels comprising additional lightweight composite panels and/or gypsum boards fastened to sides of the shaft liner frame facing away from the stairwell shaft and forming second auxiliary vertical walls, each second auxiliary vertical wall being angled relative to one or more adjacent second auxiliary vertical walls to at least partially enclose or hide the shaft liner frame,
the main lightweight composite panels and additional lightweight composite panels, when included, each comprising:
a foam core having a first surface and a second surface opposite the first surface;
a first protective layer selected from a first fiber reinforced cementitious layer, thermoset polymer layer, or magnesium oxide layer formed over and covering at least a portion of the first surface of the foam core; and
a second protective layer selected from a second fiber reinforced cementitious layer, thermoset polymer layer, or magnesium oxide layer formed over and covering at least a portion of the second surface of the foam core.

20. The shaft liner of claim 19, wherein the main lightweight composite panels have a cross-sectional thickness in a range of about ¾ inch to about 1½ inch, or about ⅞ inch to about 1¼ inch, or about 1 inch, and wherein the second and third auxiliary panels have a cross-sectional thickness in a range of about ⅜ inch to about ⅝ inch, or about 7/16 inch to about 9/16 inch, or about ½ inch.
